(19) United States
(12) Patent Application Publication
(10) Pub. No.: US 2021/0005879 A1
(43) Pub. Date: Jan. 7, 2021

(54) MULTI-LAYERED GRAPHENE ELECTRODES, MATERIALS, AND PRECURSORS THEREOF

(71) Applicant: Cornell University, Ithaca, NY (US)

(72) Inventors: Yong Lak JOO, Ithaca, NY (US); Mohammed ALAMER, Ithaca, NY (US)

(21) Appl. No.: 16/613,709

(22) PCT Filed: May 15, 2018
(86) PCT No.: PCT/US2018/032772

§ 371 Date: Nov. 14, 2019

Related U.S. Application Data
(60) Provisional application No. 62/506,359, filed on May 15, 2017.

(51) Int. Cl. H01M 4/133; H01M 4/36; H01M 4/131; H01M 10/0525; H01M 4/38; H01M 4/1395; H01M 4/62; H01M 4/04; H01M 4/66; H01M 4/1393; H01M 4/134; H01M 4/1391; H01M 4/02

(52) U.S. Cl. CPC H01M 4/133; H01M 2004/021; H01M 4/131; H01M 10/0525; H01M 4/386; H01M 4/1395; H01M 4/623; H01M 4/0419; H01M 4/661; H01M 4/1393; H01M 4/0471; H01M 4/134; H01M 4/1391; H01M 4/0435; H01M 2004/027; H01M 4/366

(57) ABSTRACT

Provided herein are high performance electrodes, electrode materials, and precursors thereof. Also provided herein are processes of generating the same. Provided in certain embodiments herein are systems and processes for manufacturing electrode materials and/or electrodes, including thin layer electrodes, such as battery electrodes and/or electrode materials (e.g., lithium ion or lithium sulfur battery negative electrode materials and/or electrodes) (e.g., the thin layer electrode comprising a carbon and silicon).

### CROSS REFERENCE TO RELATED APPLICATIONS

This application claims priority to U.S. Provisional Application No. 62/506,359, filed on May 15, 2017, the disclosure of which is hereby incorporated by reference.

### FIELD OF THE INVENTION

The field relates to electrodes, particularly negative electrodes in lithium ion batteries, cells and batteries comprising the same, and the manufacturing thereof.

### BACKGROUND OF THE INVENTION

Batteries comprise one or more electrochemical cell, such cells generally comprising a cathode, an anode and an electrolyte. Lithium ion batteries are high energy density batteries that are fairly commonly used in consumer electronics and electric vehicles. In lithium ion batteries, lithium ions generally move from the negative electrode to the positive electrode during discharge and vice versa when charging. In the as-fabricated and discharged state, lithium ion batteries often comprise a lithium compound (such as a lithium metal oxide) at the cathode (positive electrode) and another material, generally carbon, at the anode (negative electrode).

### SUMMARY OF THE INVENTION

Provided in certain embodiments herein are systems and processes for manufacturing electrode materials and/or electrodes, including thin layer electrodes, such as battery electrodes and/or electrode materials (e.g., lithium ion or lithium sulfur battery negative electrode materials and/or electrodes) (e.g., the thin layer electrode comprising a carbon and silicon). In some instances, such materials and/or electrodes have excellent capacities, good capacity retention, high volumetric energy density (and high overall density), and/or other advantages that are discussed herein. Alternate approaches to achieving higher performance materials and electrodes have had extremely limited and incremental success, with some attempts resulting in catastrophic failure, and/or development of un-scalable, cost prohibitive, and/or otherwise non-commercializable products and processes. In some embodiments, provided herein are products and processes suitable for high throughput manufacturing and production, including roll-to-roll processing, of high performance materials and electrodes, such as described in more detail herein.

Provided in some embodiments herein is a process for manufacturing an electrode material (e.g., silicon-graphene electrode material), an electrode (e.g., silicon-graphene electrode), or a precursor of an electrode material or electrode. In specific embodiments, the electrode material, electrode, or precursor thereof comprises an electrode active material (e.g., silicon, a silicon oxide, or a combination thereof), such as in the form of particles (e.g., nano- and/or micro-scale particles) comprising the same. In some embodiments, an electrode or electrode material provided herein comprises a graphenic (e.g., multi-layered) component and a (e.g., non-graphenic and non-graphitic) active electrode material, such as wherein the graphenic component forms a carbonaceous web securing the active electrode material therein.

In specific embodiments, a graphenic component utilized in a process or product provided herein is a multi-layered graphenic component. While single-layered graphenic components give excellent results, the capacity retention over many cycles may not be sufficient for certain commercial applications. As such, there is a need for electrodes and electrode materials with higher capacity retention. In some instances, multi-layered graphene components provided herein provide excellent performance parameters, including capacity retentions of up to 10% or more better than the capacity retentions observed for single-layered graphene components. In some instances, high capacity active electrode materials such as silicon are highly susceptible to catastrophic failure due to various effects, such as expansion, pulverization, SEI formation, cracking, impingement, and the like. In certain instances, the graphenic components described herein function to protect the active electrode materials, such as silicon, by keeping the active electrode material attached to the electrode (e.g., by trapping it in a web), by reducing and/or inhibiting aggregation by wrapping individual or small groups of active electrode material particles (e.g., thereby reducing impingement effects), by reducing electrolyte interactions (e.g., thereby reducing SEI formation and the corresponding negative effects), and/or other effects. In certain instances, thicker (multi-layered) graphenic components have improved structural integrity, which facilitates maintenance of the graphenic web and/or pockets protecting the active electrode materials during expansion and shrinking of the active electrode materials (e.g., during lithiation and de-lithiation, respectively), which can reduce the incidence of exposure of the active electrode material to the electrolyte and/or detachment of active electrode material from the electrode or electrode material.

In certain embodiments, a multi-layered oxidized graphenic component (e.g., graphene oxide) material is utilized in a process of manufacturing an electrode, electrode material, or precursor thereof, as described herein. In some embodiments, a multi-layered graphenic component (e.g., reduced graphene oxide) material is utilized in an electrode, electrode material, or precursor thereof, such as afforded following a (e.g., thermal) reduction step described herein. In various embodiments, any suitable source of graphenic component is optionally utilized. In some embodiments, the graphenic component is derived from synthetic graphite or natural graphite (e.g., natural flake graphite).

Provided in certain embodiments herein is a process for manufacturing a film (e.g., an electrode film, or a precursor thereof). In some embodiments, the process comprises depositing a composition or film on a substrate (e.g., a current collector, such as a metal foil). In certain embodiments, the composition comprises an active electrode material (e.g., a plurality of particles comprising SiOx) and a (e.g., multi-layered) graphenic component.

In certain embodiments, the process further comprises thermally treating the composition or film. In some instances, such as wherein a graphenic component with high oxygen content (e.g., graphene oxide) is utilized as the carbon inclusion material(s) thermal treatment of the first (e.g., base) composition and/or film functions to reduce the graphenic component (e.g., from graphene oxide to reduced graphene oxide). In some instances, the thermally treated film is utilized as an electrode provided herein with or without further processing.

Electrodes (e.g., anodes) and electrode materials provided herein can be used in any suitable battery, energy storage, or other electrode containing device. In some embodiments, the electrode provided herein is useful in a lithium battery, such as a lithium ion or lithium sulfur battery. In specific embodiments, the battery comprises the electrode (e.g., as an anode), a separator, and a second electrode (e.g., a cathode), with the separator configured between the two electrodes. In some instances, the cathode of the lithium ion battery is a lithium metal oxide, lithium metal phosphate, or other suitable material. In alternative instances, the cathode of the lithium sulfur battery comprises a sulfur compound (e.g., a sulfide, polysulfide, organosulfur, sulfur, or the like), such as deposited on a carbon substrate (e.g., a porous carbon substrate).

In specific embodiments, a plume or aerosol is generated by providing a fluid stock to a first inlet of a first conduit of a nozzle, the first conduit being enclosed along the length of the conduit by a first wall having a first interior surface and a first exterior surface, the first conduit having a first outlet, and providing a voltage to the nozzle. In some embodiments, in a process herein, a plume or aerosol (is generated by electrospraying the fluid stock (e.g., with an electrospray nozzle). In specific embodiments, the plume or aerosol is generated in the presence of a high velocity gas (e.g., air) (e.g., in a similar or identical direction, such as described herein), such as having a velocity of at least 0.1 m/s (e.g., at least 0.5 m/s, or more, such as described herein). In certain embodiments, a high velocity gas is provided by providing a pressurized gas (e.g., air), such as to a nozzle producing the plume or aerosol.

In certain embodiments, a plume or aerosol is generated by (i) providing a fluid stock to a first inlet of a first conduit of a nozzle, the first conduit being enclosed along the length of the conduit by a first wall having a first interior surface and a first exterior surface, the first conduit having a first outlet, (ii) providing a voltage to the nozzle, and (iii) providing a pressurized gas to a second inlet of a second conduit of the first nozzle, the second conduit having a second inlet and a second outlet. In some instances, the second conduit is positioned along (e.g., in a sustainably similar or identical direction, such as described herein) or around the first conduit, such as wherein at least a portion of the second conduit being positioned in surrounding relation to the first conduit. In specific embodiments, the second conduit is enclosed by a second wall, the second wall having a second interior surface. The (e.g., shortest) distance between the interior surface of the second wall and the exterior surface of the first wall is any suitable distance, such as about 0.01 mm to about 30 mm. In some embodiments, the distance between the interior surface of the second wall and the exterior surface of the first wall is suitable for providing a desired velocity at the nozzle outlet (e.g., at the first and/or second outlet), such as at least 0.5 m/s, or other suitable velocity described herein.

In certain embodiments, provided herein are films (e.g., thin films), such as electrodes, electrode materials, or precursors thereof, comprising a composition, such as manufactured according to a process herein. In some embodiments, the film or compositions comprises at least 40 wt % (e.g., about 50 wt. % to about 95 wt. %) active electrode material (e.g., SiOx) or inclusions comprising active electrode material (e.g., SiOx).

Provided in specific embodiments herein is a thin film comprising a plurality of particles (e.g., comprising active electrode material) secured within one or more carbonaceous web, the carbonaceous web comprising a (e.g., multi-layered) graphenic component. In some embodiments, the plurality of particles and the graphenic components are present in the composition or film in a particle to graphenic component weight ratio of about 1:10 to about 20:1. In specific embodiments, the particles having an average smallest dimension of about 0.01 micron to about 10 micron. In further embodiments, the thin film having an average film thickness of about 50 micron or less.

In some embodiments, a substrate provided herein is a conductive substrate, such as a metal (e.g., metal foil), such as comprising aluminum or copper. In certain embodiments, herein, a film or composition is collected on a substrate, such as wherein the substrate has a substrate surface in opposing relation to the nozzle.

In some embodiments, a substrate is affixed to or a part of a conveyor system. In specific embodiments, a substrate is provided in a roll, unrolled and conveyed in opposing relation to a nozzle (or bank of nozzles) (e.g., collecting a composition or film on a surface thereof), and re-rolled (e.g., a roll-to-roll process). In specific embodiments, the composition or film is subjected to reductive conditions (e.g., thermos-reductive conditions suitable for reducing the oxygen content of a carbon inclusion (e.g., oxidized graphenic component) prior to or following re-rolling.

Any suitable active electrode material is optionally utilized, and is generally different from the carbon inclusion material. In specific embodiments, the active electrode material is utilized in a process, composition, electrode or material herein in the form of an inclusion particle comprising the active electrode material. In some embodiments, the active electrode material is a silicon containing material, such as is active in lithium batteries. In specific embodiments, the silicon-containing material has the formula SiOx, wherein 0≤x<2. Preferably, 0≤x≤1.5. More preferably, 0≤x≤0.5. In some embodiments, the active electrode material-containing particles have an average smallest dimension of about 0.1 micron to about 50 micron (e.g., about 0.1 micron to about 15 micron, or about 0.5 to about 5 micron). Some preferred active electrode material inclusion (e.g. particle) morphologies, including sizes, are further described in more detail herein and in co-pending U.S. Patent Application entitled “Active Materials for High Performance Electrodes, Materials, and Precursors Thereof,” which is incorporated by reference herein in its entirety.

Any suitable graphenic component is optionally used in a process or composition herein. Exemplary carbon inclusion materials include carbon allotropes and analogs or derivatives thereof, such as those modified with hydrogen, oxygen, nitrogen, sulfur, halide, or the like, or combinations thereof. In some embodiments, the graphenic component can also include structural defects, such as opened or modified rings, or the like. In specific embodiments, the graphenic component comprises graphene, graphene oxide, reduced graphene oxide, or a combination thereof. Unless otherwise stated, reference to such materials includes those modified with other elements (e.g., less than 5 wt. %, less than 3 wt. %, less than 1 wt. %, or the like—for clarity, such amounts don't refer to the oxygen content of graphene oxide or reduced graphene oxide unless otherwise stated herein), such as hydrogen, oxygen, nitrogen, sulfur, halides, or the like, or combinations thereof and are pristine or comprise defects. In specific embodiments, the graphenic components (graphene oxides) comprise at least 50 wt. % carbon and about 10 wt. % to about 50 wt. % oxygen (e.g., and less than 5 wt. % other elements, such as described herein). In some embodiments, the graphenic component (e.g., following reductive, such as thermo-reductive treatment) are graphenic components (e.g., reduced graphene oxides) comprising at least 85 wt. % carbon and about 0.1 wt. % to about 15 wt. % oxygen (e.g., and less than 5 wt. % other elements, such as described herein). More details and/or alternative carbon inclusion (e.g., graphenic) components are described in more detail herein. In some embodiments, the graphenic component have an average lateral dimension that is equal to or greater than the average of the smallest dimension of the particles (e.g., at least 1.5 times, at least 2 times, at least 3 times, at least 5 times, or the like). In some specific embodiments, the average lateral dimension of the graphenic component is about 10 times or less the average of the smallest dimension of the particles. In some embodiments, the graphenic component comprises at least two layers (i.e., at least two stacked graphenic sheets). In specific embodiments, the multi-layered graphene component comprises (e.g., on average) at least 3 layers. In more specific embodiments, the multi-layered graphene component comprises (e.g., on average) at least 5 layers. In some embodiments, the multi-layered graphene component comprises (e.g., on average) about 2 to about 50 layers. In specific embodiments, the multi-layered graphene component comprises (e.g., on average) about 5 to about 50 layers. In more specific embodiments, the multi-layered graphene component comprises (e.g., on average) about 5 to about 25 layers.

In certain embodiments, the weight ratio of active electrode material or active electrode material containing inclusions to graphenic component, in a fluid stock provided herein is at least 1:4 (e.g., at least 1:2 or 1:2 to 10:1). In more specific embodiments, the weight ratio is at least 1:1, e.g., at least 2:1, or at least 3:2.

In some embodiments, a film or composition is highly loaded on the substrate, such as having a loading by area (“areal loading”) of at least 0.3 mg/cm². In more specific embodiments, the loading of the first composition or domain is at least 0.5 mg/cm², such as at least 1 mg/cm².

In certain embodiments, a film provided herein (e.g., pre- or post-reductive or thermal treatment) is a thin film, such as having an overall thickness (e.g., but not the substrate) of about 100 micron or less (e.g., about 50 micron or less, about 5 micron to about 25 micron, about 10 micron to 20 micron, or the like). In specific embodiments, the film has an average thickness of about 5 micron to about 35 micron. In certain embodiments, the film has a thickness variation of less than 50%, e.g., less than 30%, less than 20%, less than 10%, or the like. Any suitable bulk density is contemplated, such as about 0.3 grams per cubic cm or more, such as about 0.5 grams per cubic cm or more.

In some embodiments, a film provided herein has an externally exposed surface, the externally exposed surface comprising at least 90% (e.g., at least 95%, at least 97%, at least 98%, at least 99%, or the like) graphenic component by surface area. In certain embodiments, less than 5% (e.g., less than 3%, less than 2%, less than 1%, or the like) of the surface of the film is comprised of the active electrode material.

In certain embodiments, the graphenic component constitute at least 70 wt. % of the film surface. In more specific embodiments, the graphenic component constitute at least 80 wt. % of the film surface. In still more specific embodiments, the carbonaceous components constitute at least 90 wt. % (e.g., at least 95 wt. %) of the film surface. In some embodiments, the active electrode material or active electrode material-containing inclusions constitute about 50 wt. % to about 95 wt. % of the film. In certain embodiments, the carbonaceous components constitute about 5 wt. % to about 50 wt. % of the film.

In some embodiments, within a film described herein, the one or more graphenic web provided therein (e.g., a continuous web extending throughout the composition or domain of the film) defines a plurality of pockets with one or more of the particles (active electrode material containing inclusions) being configured therewithin. In specific embodiments, 1≤b≤20, wherein b is the average number of particles configured within the pocket(s) having particles configured therewithin. In certain instances, such as wherein smaller particles are utilized, the number of particles configured within the pockets can be higher.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, unless otherwise stated, values and characteristics described for individual components herein also include disclosure of such values and characteristics as an average of a plurality (i.e., more than one) of such components. Similarly, disclosure of average values and characteristics herein also includes a disclosure of an individual value and characteristic as applied to a single component herein.

### BRIEF DESCRIPTION OF THE DRAWINGS

FIG. 1 illustrates an electrode comprising a carbon web securing nanostructures on a substrate.

FIG. 2 shows an exemplary illustration of a gas controlled electrospray system and processes provided herein.

FIG. 3 shows an exemplary illustration of a process of a graphene component securing nanostructures to a substrate.

FIG. 4 shows an exemplary illustration of a plurality of carbon inclusions (graphene components) collectively forming a carbon web to secure active electrode structures on a substrate.

FIG. 5 illustrates exemplary microscopic images of exemplary carbon webs securing active electrode components to a substrate.

FIG. 6 illustrates specific capacity data for various exemplary electrodes provided herein where single layered graphenic component (filled circles) and multi-layered graphenic component (triangles and open circles) are utilized.

FIG. 7 illustrates exemplary reduced graphene oxide (rGO) structures.

FIG. 8 illustrates exemplary electrospray nozzle apparatuses utilized to manufacture certain electrodes and electrode materials provided herein.

FIG. 9 illustrates exemplary particles comprising active material in (a) pristine form, as well as (b) and (c) covered by carbon (at various zoom levels).

FIG. 10 illustrates the capacity retention percentage for various exemplary electrodes provided herein where single layered graphenic component (filled circles) and multi-layered graphenic component (triangles and open circles) are utilized.

FIG. 11 illustrates specific capacity data for various exemplary electrodes provided herein where single layered graphenic component (filled circles) and multi-layered graphenic component (prepared from natural flake graphite) (triangles and open circles) are utilized.

FIG. 12 illustrates the capacity retention percentage for various exemplary electrodes provided herein where single layered graphenic component (filled circles) and multi-layered graphenic component (triangles and open circles) are utilized.

FIG. 13 illustrates exemplary graphene oxide (GO) structures.

### DETAILED DESCRIPTION OF THE INVENTION

Some embodiments provided herein describe a process for manufacturing an electrode or electrode material (e.g., for use in a lithium battery, such as a lithium ion or lithium sulfur battery). Other embodiments provided herein describe compositions, films, and/or electrodes, such as comprising plurality of silicon-containing particles and a plurality of multi-layered graphenic components (e.g., for use as an electrode or electrode material described herein).

Silicon anodes are being developed for use in lithium batteries. Silicon has a larger energy density than currently used anode materials, but the large volume change of silicon when lithium is inserted is a major obstacle in commercializing lithium-silicon batteries. Also, silicon containing electrode materials suffer from poor performance characteristics, such as poor capacity retention on cycling, such as due to the formation of solid electrolyte interface (SEI) layers, pulverization, and the like. In some instances, silicon in a battery forms a solid electrolyte interface layer and this layer cracks and the silicon fragments and/or delaminates, limiting the number of charge/discharge cycling of the battery. Spraying active electrode material containing inclusions (e.g., silicon particles) with a graphenic component (e.g., graphene oxide) forms films with less silicon or other (non-graphitic/graphenic) active material on the surface, and the load of silicon can be increased without compromising battery performance. In addition, in some instances, use of rigid graphenic components facilitates the formation of a stable graphenic web, which in turn facilitates good film and web integrity, reducing the exposure of silicon or other active material exposed the surface of the electrode during cell cycling. In some instances, such configurations further protect the active electrode material and increases cell performance, even while maintaining a constant overall active electrode material (e.g., silicon) loading. In some of these instances, with the use of thinner (e.g., single layer) graphenic components, active (e.g., silicon) material becomes uncovered exposed to electrolyte during cycling (e.g., due to the “flimsy” or less rigid nature of thin graphenic structures), causing rapid decline in cell performance, such as through pulverization, SEI formation, fragmentation, delamination, or the like, limiting the battery's lifecycle. Controlled and uniform systems whereby silicon materials are protected from adverse (e.g., SEI formation, pulverization, etc.) effects are desired (e.g., with more graphenic components that envelope active electrode material (e.g., silicon and/or silicon oxide containing) particles, minimizing SEI formation and trapping active material particles, such as during cracking and/or breaking during lithiation/delithiation cycling). In certain embodiments, provided herein are compositions and processes suitable for providing such results.

In certain embodiments, provided herein is a process for manufacturing an electrode, an electrode material, an electrode precursor, an electrode precursor material, and/or a part, composition, or domain thereof. In specific embodiments, such processes involve generating a plume or aerosol in from a fluid stock comprising a plurality of inclusion components and a liquid medium. In more specific embodiments, generation of an electrode, electrode material, or active electrode part, composition, or domain thereof, or a precursor thereof comprises generating a plume or aerosol from a fluid stock comprising a plurality of inclusions and a liquid medium, the plurality of inclusions comprising a (e.g., multilayered) graphenic component and an active electrode component (e.g., particles comprising active electrode, such as SiOx). In some embodiments, a process herein further comprises generating a protective or top coat, part, composition, or domain of an electrode material, electrode, or precursor thereof comprises generating a plume or aerosol from a fluid stock comprising a plurality of inclusions and a liquid medium, the plurality of inclusions comprising a (e.g., multi-layered) graphenic component. In specific embodiments, processes herein comprise generating a first or base coat comprising an active material (e.g., inclusions comprising SiOx) and a (e.g., multi-layered) graphenic component (such as graphene oxide in precursor materials or reduced graphene oxide in electrode materials) and a protective or top coat comprising a (e.g., multi-layered) a graphenic component (such as graphene oxide in precursor materials or reduced graphene oxide in electrode materials).

In some embodiments, provided herein is a process for (i) generating a plume or aerosol from a fluid stock, the fluid stock comprising a (e.g., multi-layered) graphenic component and an active electrode material (e.g., SiOx) inclusion. In specific embodiments, the plume or aerosol is generated and deposited as a composition on a substrate (e.g., and optionally followed by the second plume or aerosol being generated and deposited on the first (e.g., base) composition (or layer or domain) as a second (e.g., top) composition (or layer or domain)). In specific embodiments, the plumes or aerosols are generated using a suitable technique, such as an electrospray technique. In some embodiments, the process further comprises generating the plume(s) or aerosol(s) in the presence of a high velocity gas. In specific instances, the high velocity gas facilitates the fine dispersion of the plume or aerosol particulates, which, in turn, facilitates the controlled and uniform deposition of the inclusion parts on a substrate surface (e.g., the first composition forming a substrate surface for the second composition). In some instances, the direction of the flow of the gas and the plume/aerosol are in the same general direction (e.g., having a directional mean within 15 degrees, 10 degrees, 5 degrees, or the like of each other). Also provided herein are the fluid compositions described herein, the aerosols and plumes described herein, and other systems, process steps, intermediates, and the like described herein.

In specific embodiments, a fluid stock is electrosprayed with a gas (e.g., a controlled gas flow). In certain embodiments, the fluid stock and the gas are ejected from an electrospray nozzle in a similar direction. In some instances, the direction of ejection of the fluid stock and the gas from the electrospray nozzle is within about 30 degrees of one another, or, more preferably within about 15 degrees of one another (e.g., within about 10 degrees or within about 5 degrees of one another). In certain embodiments, the fluid stock and the gas are configured to be ejected from the nozzle in a coaxial or substantially coaxial configuration. In some instances, configurations and processes described herein allow for an enhanced driving force of electrospray, combining the driving forces of electric field gradient with high speed gas. In some instances, configurations provided herein allow for process throughput up to tens or hundreds of times greater than simple electrospray manufacturing and allow for the electrospray of high viscosity and/or highly loaded (e.g., with carbon and silicon inclusion materials described herein) fluids. Moreover, in some instances, such electrospray techniques and systems provided herein allow for the manufacture of highly uniform materials (e.g., compositions, films, electrodes, electrode materials, and electrode precursor materials). By contrast, other or conventional electrospray is not generally of commercial use in many applications because of, e.g., non-uniform deposition of drops and non-uniform dispersion of fillers in and between droplets, especially for high loaded systems. In addition, in some instances, the throughput capabilities of other or conventional electrospray systems are not sufficient to be commercially useful in some applications. However, other suitable techniques (e.g., electrospray techniques utilizing the fluid stocks and/or inclusions provided herein) are optionally utilized in the manufacture of electrodes or depositions described herein, as applicable.

In some instances, electrospray (e.g., using a process and/or system provided herein) of the fluid stock results in the formation of a plume comprising a plurality of droplets (collectively referred to herein so as to encompass, e.g., droplet solutions, droplet suspensions, and/or solid particles in an electrospray plume), or of a jet, which subsequently deforms into a plume comprising a plurality of droplets. In certain instances, electrospray (e.g., using a process and/or system provided herein) of a fluid stock, such as provided herein, results in the formation of a plume comprising a plurality of droplets. In some instances, the processes described herein results in the formation of small droplets (e.g., micron- or nano-scale droplets) having highly uniform size distributions (e.g., especially relative to standard electrospray techniques). In certain instances, this uniformity allows for much greater control of deposition formation, such as thickness, thickness uniformity, compositional uniformity (e.g., in composites), and the like. In certain embodiments, films provided herein have an average thickness (df) that is about 10 mm or less, such as about 5 mm or less, about 2 mm or less, or about 1 mm or less. In certain embodiments, such as wherein the film is utilized as a direct deposit electrode, the thickness of the film is about 500 micron (micrometer, pm) or less, such as about 250 micron or less, about 200 micron or less, about 100 micron or less, about or the like (e.g., down to about 1 micron, about 5 micron, about 10 micron, 25 micron, 50 micron, 100 micron, or the like). In certain embodiments, the films provided herein have good thickness uniformity, such as wherein the thinnest portion of the film is >d_{f}/10, >d_{f}/5, >df/4, >d_{f}/3, >d_{f}/2, or the like. In further or alternative embodiments, the thickest portion of the film is <10×d_{f}, <5×d_{f}, <3×d_{f}, <2×d_{f}, <1.5×d_{f}, <1.2×d_{f}, or the like. In preferred embodiments, the minimum thickness of the film is greater than 0.9 d_{f}, (more preferably greater than 0.95 d_{f}) and the maximum thickness of the film is less than 1.1 d_{f}, (more preferably, less than 1.05 d_{f}).

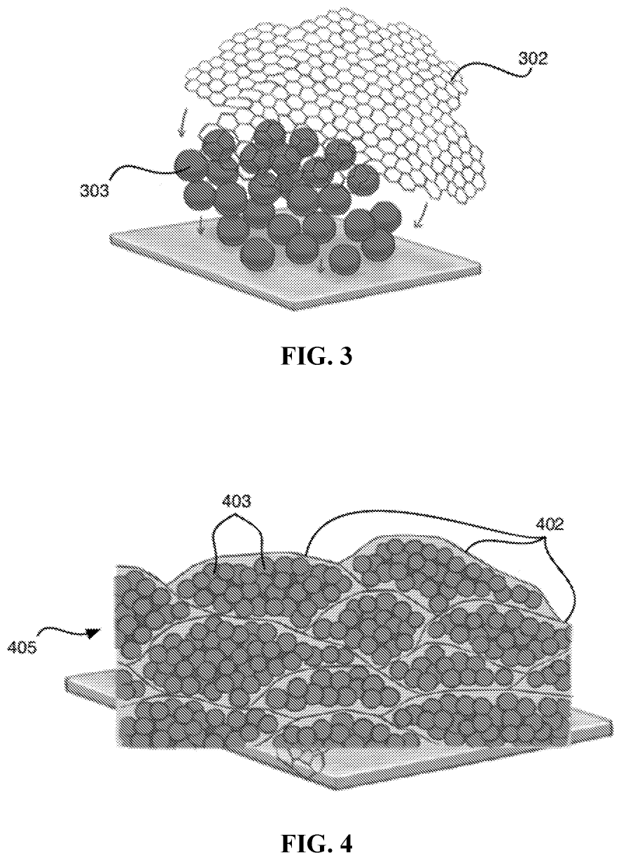

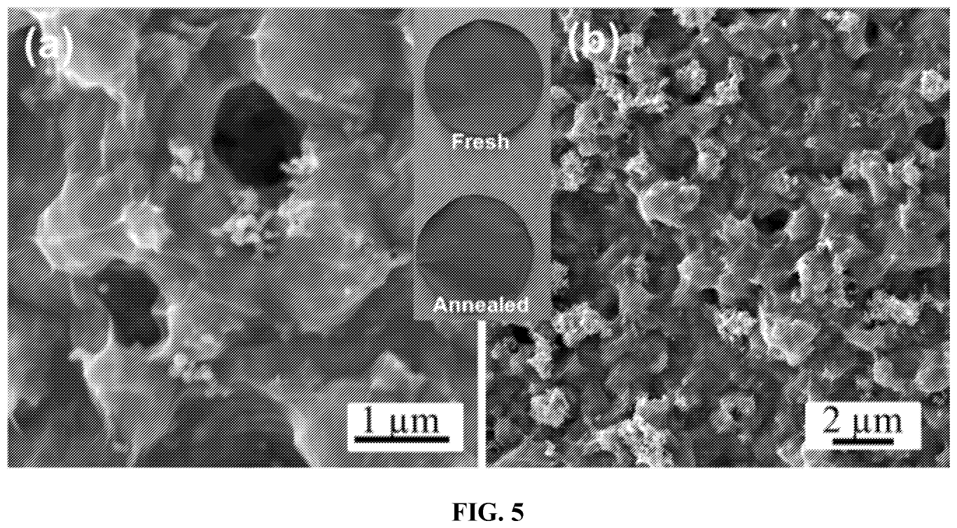

In some instances, electrospray techniques (e.g., provided herein) facilitate the formation of high capacity electrodes, such as those described herein. FIG. 2 shows an exemplary illustration of a gas controlled electrospray system provided herein 200. In some embodiments, gas-controlled systems (and processes) provided herein provide electrospray (e.g., using V_{DC} or V_{AC}) of a fluid stock with a gas (illustrated by the downward arrows) 201 (e.g., having a controlled flow, such as circumferentially configured with the dispensing of the fluid stock) from a nozzle 202 (e.g., coaxially arranged, as illustrated in FIG. 2). In some embodiments, with the flow of air, the droplets 203 proximal to the nozzle are smaller relative to non-gas controlled techniques (e.g., in some instances due to the controlled air flow at the nozzle end 204), and even smaller still as the droplets 205 move away from the nozzle toward the collector (droplets distal to the nozzle 206 and/or proximal to a collector 207). In some embodiments, such uniformity (e.g., uniformity of size, horizontal distribution, etc.) of dispersion of small droplets provides for a deposition 208 having a greatly improved uniformity of thickness, dispersion of inclusions, etc. As illustrated in FIG. 3, uniform dispersion of active materials and carbon materials in a fluid stock and resulting electrospray plume facilitate the deposition of a graphenic component (e.g., graphene, GO, rGO sheet) 302 over a plurality of active material inclusions 303, thereby facilitating the wrapping of the active material inclusions 303 therein. As illustrated in FIG. 4, further deposition of graphenic component 402 and active material inclusions 403 provides a layered electrode structure 405 comprising a plurality of active material inclusions 405 wrapped and/or secured within a web of the carbon material 402. Further, FIG. 4 illustrates a plurality of graphene envelopes comprising an external surface and an internal surface. The graphene envelope optionally comprises one or more graphene component, such as illustrated in FIG. 4. In addition, various graphene components of a composition described herein is a part of one or more graphene envelopes described herein. Moreover, as illustrated, in some instances, the external surface of one graphene envelope, or a portion thereof, optionally forms a portion of the internal surface of an adjacent graphene envelope. Further, in some embodiments, the internal surface of a graphene envelope defines a graphene envelope pocket, such as illustrated in FIG. 4. In certain embodiments, within the graphene envelope, one or more particles comprising an electrode active material is configured within the graphene envelope pocket. FIG. 5 illustrates images of exemplary electrodes provided herein comprising electrode active material wrapped within a carbon web—or a plurality of graphene envelopes with active electrode material configured therewithin (such as demonstrated by the illustration of FIG. 4).

In some embodiments, such systems, processes and process steps are configured to facilitate high throughput electrospraying using a single or a banked nozzle system. In specific embodiments, the systems and processes are configured for direct current voltage (V_{DC}) or alternating current voltage (V_{AC}) electrospraying, such as gas-controlled, direct current voltage or alternate current voltage (V_{AC}) electrospraying. In some embodiments, processes and systems provided herein are suitable for and/or configured to manufacture electrode precursor materials, electrode materials, uniform electrodes (e.g., on a current collector), such as having uniform thickness, capacity, component distribution, etc., or the like.

In some instances, ejecting of a charged fluid stock from an electrospray nozzle produces a fluid jet, which is disrupted to form a plume comprising a plurality of droplets (or plume particulates). In certain instances, such droplets are in varying states of dryness (e.g., wherein more dry droplets comprise less fluid medium relative to solid inclusion materials) as they move toward a collector, with the droplets near the collector being dryer (i.e., comprising less fluid medium) (or even completely dry) than those droplets near the nozzle. In some instances, the plume comprises (e.g., especially in closest proximity to the collector substrate surface) droplets wherein all fluid medium has been evaporated. In various embodiments, a plume (or portion thereof) provided herein, comprises about 80 wt. % or less fluid, about 60 wt. % or less of a fluid, about 40 wt. % or less of a fluid, about 20 wt. % or less of a fluid, about 10 wt. % or less of a fluid, or about 5 wt. % or less of a fluid. In preferred embodiments, plume droplets (particularly in proximity to the collector substrate surface) are disrupted and small enough to reduce or minimize the number of inclusions included within each droplet. In certain instances, reducing and/or minimizing the number of inclusions in each droplets facilitates good distribution of inclusions throughout the plume, particularly in proximity to the collector. In some instances, good distribution of inclusions within the plume facilitates good distribution of inclusions as collected on the collector substrate.

Other spray techniques are generally insufficient to adequately disrupt and break apart the droplets of the plume and are insufficient to provide good distribution of the inclusion materials in the plume and on the collector substrate so as to provide dispersions with good uniformity, particularly in systems comprising multiple inclusion types, such as an active electrode material inclusion type and a graphenic component (used interchangeably herein with “graphene component”) inclusion type. Instead, typical spray techniques have been observed to produce particle agglomerations, including co-agglomerations with poor dispersion uniformity and control, without which active electrode/carbon systems, particularly comprising a silicon active electrode material, exhibit poor, insufficient, or non-existent performance characteristics. In some embodiments, when electrospray techniques are utilized, a plume or aerosol resulting therefrom is electrostatically charged.

In certain instances, processes and individual spray processing steps provided herein comprise generating a plume or aerosol (e.g., by electrospraying a fluid stock) with a high velocity gas (e.g., ≥0.1 m/s, ≥0.5 m/s, ≥1 m/s, ≥5 m/s, ≥10 m/s, ≥20 m/s, ≥25 m/s, ≥50 m/s, or other velocities provided herein). In some instances, an electrostatically charged fluid stock is injected into a stream of high velocity gas. In certain instances, the high velocity gas facilitates further disruption (e.g., breaking apart) of the droplets formed during electrospray of the fluid stock. In some embodiments, droplets of the plume comprise (e.g., on average) less than 100 inclusions (e.g., sum of active electrode material component inclusion(s) and graphene component inclusion(s) in the droplets), less than 50 inclusions, less than 20 inclusions, less than 10 inclusions or the like. In specific embodiments, the collector is a distance d away from the electrospray nozzle and the droplets of the plume within d/2, d/3, or d/4 away from the collector comprise (e.g., on average) about 100 inclusions or less, about 50 inclusions or less, about 20 inclusions or less, about 10 inclusions or less, about 5 inclusions or less, about 3 inclusions or less, or the like. In some instances, the good dispersion of the droplets and the low concentration of inclusions per droplets facilitates the formation of a well-dispersed and well-controlled multi-component system, such as described herein.

In certain embodiments, a process provided herein comprises producing an electrostatically charged plume comprising a plurality of particles and/or droplets (e.g., an area or section of air comprising a plurality of particles and/or droplets dispersed therein). In specific embodiments, the plurality of particles and/or droplets have an average diameter of about 500 micron or less, about 250 micron or less, about 100 microns or less, about 50 microns or less, less than 30 micron, about 20 microns or less, less than 15 micron, or about 10 microns or less. In still more specific embodiments, the plurality of particles and/or droplets have an average diameter of about 5 microns or less, e.g., about 1 micron or less. In certain embodiments, the size of the particles and/or droplets is highly uniform, with the standard deviation of the particle and/or droplet size being about 50% of the average size of the particles and/or droplets, or less (e.g., about 40% or less, about 30% or less, about 20% or less, about 10% or less, or the like) (e.g., at any given distance from the nozzle, e.g., about 10 cm or more, about 15 cm or more, about 20 cm or more, about 25 cm or more, from the nozzle).

In specific embodiments, electrospraying of a fluid stock or producing an electrostatically charged plume of a fluid stock comprises (i) providing a fluid stock to a first inlet of a first conduit of an electrospray nozzle, the first conduit being enclosed along the length of the conduit by a wall having an interior surface and an exterior surface, the first conduit having a first outlet; and (ii) providing a voltage to the electrospray nozzle (e.g., thereby providing an electric field). In some embodiments, a fluid stock comprises a plurality (i.e., more than one) of active electrode material (e.g., silicon) containing particles, a plurality of (e.g., multi-layered) graphenic components, and fluid medium (e.g., an aqueous medium, such as comprising water). In specific embodiments, the plurality of active electrode material (e.g., silicon) containing particles have at least one average dimension (e.g., overall average dimension or average smallest dimension) of less than 100 micron (μm) (e.g., about 0.5 micron to about 20 micron, such as about 1 micron to about 10 micron) (e.g., less than 50 micron, less than 20 micron, less than 10 micron, 0.2 micron to 10 micron, or less than 0.2 micron (200 nm)) (e.g., the smallest dimension). In some embodiments, the graphenic components of the fluid stock(s) and/or the collected composition(s) are oxidized graphene components (e.g., graphene oxide). In certain embodiments, the graphene components of the fluid stock(s) (and/or composition) independently comprise (e.g., on average) at least 50 wt. % carbon (e.g., about 60 wt. % to about 80 wt. % carbon). In further or alternative embodiments, the graphenic components of the fluid stock(s) and/or composition(s) independently comprise (e.g., on average) about 5 wt. % to about 50 wt. % oxygen (e.g., about 10 wt. % to about 40 wt. % oxygen). In general, wt. % of carbon inclusions as used herein to the weight percentage of an element (e.g., carbon, oxygen, hydrogen, or the like) in the carbon inclusion on an elemental basis.

In various embodiments, individual droplets (generated from a fluid stock having an active electrode inclusion and a carbon inclusion) optionally comprise either or both of the active material and/or carbon inclusions. Further, some or all of the fluid of the droplets (of the plume) may be evaporated during the electrospray process (e.g., prior to deposition). In various embodiments, concentrations of inclusion materials in droplets described herein, or a composition comprising the same, are generally higher than the concentrations of such materials in the fluid stock, or even in the jet (where evaporation of the fluid begins). In certain embodiments, droplets or compositions comprising the droplets having inclusions concentrations of at least 1.5×, at least 2×, at least 3×, at least 5×, at least 10×, or the like (e.g., wherein the inclusions make up up to 70 wt. % or more, 80 wt. % or more, 90 wt. % or more, or even 100 wt. % of the droplets or composition/plume comprising the same) of the concentrations of the fluid stock comprising the same.

In certain embodiments, processes and systems described herein are suitable for high throughput of heavily loaded fluid stocks. In addition, in some embodiments, high concentrations of graphenic component are preferred in order to facilitate good coverage of the active electrode material, good uniformity of films (e.g., thickness, dispersion, etc.), and/or the like. In certain embodiments, a fluid stock provided herein comprises at least 0.1 wt. % graphene component, at least 0.5 wt. % graphenic component, or at least 1 wt. % graphenic component, e.g., at least 2 wt. % graphenic component, at least 2.5 wt. % graphenic component, at least 3 wt. % graphenic component, at least 5 wt. % graphenic component, or the like (e.g., about 10 wt. % to about 20 wt. %, up to 20 wt. %, up to 15 wt. %, up to 10 wt. %, or the like). In certain preferred embodiments, the fluid stock(s) comprises about 2 wt. % to about 15 wt. % (e.g., about 10 wt. % to about 15 wt. %) graphenic component.

In various embodiments, a fluid stock is provided to a nozzle herein at any suitable flow rate, such as about 0.01 mL/min or more, about 0.05 mL/min or more, about 0.1 mL/min or more, about 0.2 mL/min or more, or about 0.01 mL/min to about 10 mL/min.

In some instances, the controlled air flow allows for an increase rate and uniformity in dispersion and breaking up of the jet and the plume, allowing for increased fluid stock flow rates, while also increasing deposition uniformity and performance characteristics. In certain embodiments, the fluid stock is provided to the first inlet at a rate (e.g., where a direct current voltage (Voc) is applied to the electrospray system) of about 0.01 to about 10 mL/min, e.g., about 0.05 mL/min to about 5 mL/min, or about 0.5 mL/min to about 5 mL/min. In some instances, use of alternating current configurations (e.g., wherein an alternating current voltage (Vac) is applied to the electrospray system) allow for higher throughput. In certain embodiments, the fluid stock is provided to the first inlet at a rate of about 0.1 mL/min or more, e.g., about 0.1 mL/min to about 25 mL/min, about 0.3 mL/min or more, about 0.5 mL/min or more, about 1 mL/min or more, about to about 2.5 mL/min, or about 5 mL/min or more.

In specific embodiments, a process described herein comprises providing a fluid stock to a first inlet of a first conduit of an electrospray nozzle, the first conduit being enclosed along the length of the conduit by a wall having an interior surface and an exterior surface, the first conduit having a first outlet. In specific instances, the walls of the first conduit form a capillary tube, or other structure. In some instances, the first conduit is cylindrical, but embodiments herein are not limited to such configurations.

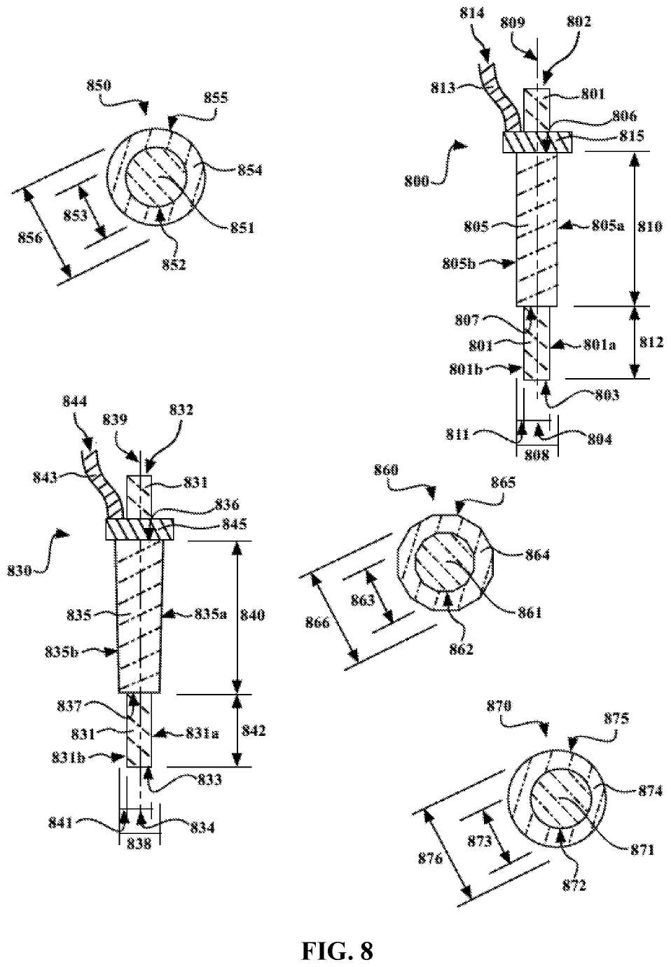

FIG. 8 illustrates exemplary electrospray nozzle apparatuses 800 and 830 provided herein. Illustrated by both nozzle components 800 and 830 some embodiments, the nozzle apparatus comprises a nozzle component comprising a first (inner) conduit, the first conduit being enclosed along the length of the conduit by a first wall 801 and 831 having an interior and an exterior surface, and the first conduit having a first inlet (or supply) end 802 and 832 (e.g., fluidly connected to a first supply chamber and configured to receive a fluid stock) and a first outlet end 803 and 833. Generally, the first conduit has a first diameter 804 and 834 (e.g., the average diameter as measured to the inner surface of the wall enclosing the conduit). In further instances, the nozzle component comprising a second (outer) conduit, the second conduit being enclosed along the length of the conduit by a second wall 805 and 835 having an interior and an exterior surface, and the second conduit having a second inlet (or supply) end 806 and 836 (e.g., fluidly connected to a second supply chamber and configured to receive a gas—such as a high velocity or pressurized gas (e.g., air)) and a second outlet end 807 and 837. In some instances, the second inlet (supply) end 806 and 836 is connected to a supply chamber. In certain instances, the second inlet (supply) end 806 and 836 are connected to the second supply chamber via a supply component. FIG. 8 illustrates an exemplary supply component comprising a connection supply component (e.g., tube) 813 and 843 that fluidly connects 814 and 844 the supply chamber (not shown) to an inlet supply component 815 and 845, which is fluidly connected to the inlet end of the conduit. The figure illustrates such a configuration for the outer conduit, but such a configuration is also contemplated for the inner and any intermediate conduits as well. Generally, the first conduit has a first diameter 808 and 838 (e.g., the average diameter as measured to the inner surface of the wall enclosing the conduit). The first and second conduits have any suitable shape. In some embodiments, the conduits are cylindrical (e.g., circular or elliptical), prismatic (e.g., a octagonal prism), conical (e.g., a truncated cone—e.g., as illustrated by the outer conduit 835) (e.g., circular or elliptical), pyramidal (e.g., a truncated pyramid, such as a truncated octagonal pyramid), or the like. In specific embodiments, the conduits are cylindrical (e.g., wherein the conduits and walls enclosing said conduits form needles). In some instances, the walls of a conduit are parallel, or within about 1 or 2 degrees of parallel (e.g., wherein the conduit forms a cylinder or prism). For example, the nozzle apparatus 800 comprise a first and second conduit having parallel walls 801 and 805 (e.g., parallel to the wall on the opposite side of the conduit, e.g., as illustrated by 801a/801b and 805a/805b, or to a central longitudinal axis 809). In other embodiments, the walls of a conduit are not parallel (e.g., wherein the diameter is wider at the inlet end than the outlet end, such as when the conduit forms a cone (e.g., truncated cone) or pyramid (e.g., truncated pyramid)). For example, the nozzle apparatus 830 comprise a first conduit having parallel walls 831 (e.g., parallel to the wall on the opposite side of the conduit, e.g., as illustrated by 831a/831b, or to a central longitudinal axis 839) and a second conduit having non-parallel walls 835 (e.g., not parallel or angled to the wall on the opposite side of the conduit, e.g., as illustrated by 835a/835b, or to a central longitudinal axis 839). In certain embodiments, the walls of a conduit are within about 15 degrees of parallel (e.g., as measured against the central longitudinal axis, or half of the angle between opposite sides of the wall), or within about 10 degrees of parallel. In specific embodiments, the walls of a conduit are within about 5 degrees of parallel (e.g., within about 3 degrees or 2 degrees of parallel). In some instances, conical or pyramidal conduits are utilized. In such embodiments, the diameters for conduits not having parallel walls refer to the average width or diameter of said conduit. In certain embodiments, the angle of the cone or pyramid is about 15 degrees or less (e.g., the average angle of the conduit sides/walls as measured against a central longitudinal axis or against the conduit side/wall opposite), or about 10 degrees or less. In specific embodiments, the angle of the cone or pyramid is about 5 degrees or less (e.g., about 3 degrees or less). Generally, the first conduit 801 and 831 and second conduit 805 and 835 having a conduit overlap length 810 and 840, wherein the first conduit is positioned inside the second conduit (for at least a portion of the length of the first and/or second conduit). In some instances, the exterior surface of the first wall and the interior surface of the second wall are separated by a conduit gap 811 and 841. In certain instances, the first outlet end protrudes beyond the second outlet end by a protrusion length 812 and 842. In certain instances, the ratio of the conduit overlap length-to-second diameter is any suitable amount, such as an amount described herein. In further or alternative instances, the ratio of the protrusion length-to-second diameter is any suitable amount, such as an amount described herein, e.g., about 1 or less.

FIG. 8 also illustrates cross-sections of various nozzle components provided herein 850, 860 and 870. Each comprises a first conduit 851, 861 and 871 and second conduit 854, 864, and 874. As discussed herein, in some instances, the first conduit is enclosed along the length of the conduit by a first wall 852, 862 and 872 having an interior and an exterior surface and the second conduit is enclosed along the length of the conduit by a second wall 855, 865 and 875 having an interior and an exterior surface. Generally, the first conduit has any suitable first diameter 853, 863 and 864 and any suitable second diameter 856, 866, and 876. The cross-dimensional shape of the conduit is any suitable shape, and is optionally different at different points along the conduit. In some instances, the cross-sectional shape of the conduit is circular 851/854 and 871/874, elliptical, polygonal 861/864, or the like.

In some instances, coaxially configured nozzles provided herein and coaxial gas controlled electrospraying provided herein comprises providing a first conduit or fluid stock along a first longitudinal axis, and providing a second conduit or gas (e.g., pressurized or high velocity gas) around a second longitudinal axis (e.g., and electrospraying the fluid stock in a process thereof). In specific embodiments, the first and second longitudinal axes are the same. In other embodiments, the first and second longitudinal axes are different. In certain embodiments, the first and second longitudinal axes are within 500 microns, within 100 microns, within 50 microns, or the like of each other. In some embodiments, the first and second longitudinal axes are aligned within 15 degrees, within 10 degrees, within 5 degrees, within 3 degrees, within 1 degree, or the like of each other. For example, FIG. 8 illustrates a cross section of a nozzle component 870 having an inner conduit 871 that is off-center (or does not share a central longitudinal axis) with an outer conduit 874. In some instances, the conduit gap (e.g., measurement between the outer surface of the inner wall and inner surface of the outer wall) is optionally averaged—e.g., determined by halving the difference between the diameter of the inner surface of the outer wall 876 and the diameter of the outer surface of the inner wall 872. In some instances, the smallest distance between the inner surface of the outer wall 876 and the diameter of the outer surface of the inner wall 872 is at least 10% (e.g., at least 25%, at least 50%, or any suitable percentage) of the largest distance between the inner surface of the outer wall 876 and the diameter of the outer surface of the inner wall 872.

In some embodiments, a process herein comprises or a system provided herein is configured to provide a voltage (e.g., V_{DC} or V_{AC}) to an electrospray nozzle, such as one provided herein. In specific embodiments, the voltage is provided to the inner conduit (e.g., the walls thereof). In certain embodiments, application of the voltage to the nozzle provides an electric field at the nozzle (e.g., at the outlet of the inner conduit thereof). In some instances, the electric field results in the formation of a “cone” (e.g., Taylor cone) at the nozzle (e.g., at the outlet of the inner conduit thereof), and ultimately a jet and/or a plume. In certain instances, after the formation of a cone, the jet and/or plume is broken up into small and highly charged liquid droplets (or particles), which are dispersed, e.g., due to Coulomb repulsion. As used herein, droplets and particles are referred to interchangeably, wherein the particles comprise droplets (e.g., comprising a liquid medium of the fluid stock) or dried particles (e.g., wherein the liquid medium of the fluid stock has been evaporated during the electrospray process).

In some embodiments, any suitable voltage (e.g., direct or alternating current voltage) is applied (e.g., to a nozzle). In specific embodiments, the voltage applied is about 8 kV_{DC} to about 30 kV_{DC}, e.g., about 10 kV_{DC} to about 25 kV_{DC}. In other specific embodiments, the voltage applied is about 10 kV_{AC} (e.g., wherein the voltage refers to the root mean square voltage (Vᵣₘₛ)) or more. In more specific embodiments, the voltage applied is about 20 kVAc or more, e.g., about 30 kV_{AC} or more. In some specific embodiments, the voltage applied is about 10 kV_{AC} to about 25 kV_{AC}. In certain embodiments, a power supply system is configured to provide the voltage to the nozzle. In some embodiments, the alternating voltage (V_{AC}) has any suitable frequency, such as about 25 Hz or more, e.g., about 50 Hz to about 500 Hz. In more specific embodiments, the frequency is about 60 Hz to about 400 Hz, e.g., about 60 Hz to about 120 Hz, or about 60 Hz to about 250 Hz.

In some embodiments, the voltage applied to a nozzle is about 8 kV_{DC} to about 30 kV_{DC}. In specific embodiments, the voltage applied to the nozzle is about 10 kV_{DC} to about 25 kV_{DC}. In other embodiments, the voltage applied to the nozzle is about 10 kV_{AC} or more (e.g., about 15 kV_{AC} or more, or about 20 kV_{AC} to about 25 kV_{AC}). In some embodiments, the alternating voltage (V_{AC}) has a frequency of about 50 Hz to about 350 Hz.

In certain embodiments, a process herein provides a pressurized gas to an outer inlet of an outer conduit of an electrospray nozzle. In some embodiments, the outer conduit is enclosed along the length of the conduit by an outer wall having an interior surface, the outer conduit having an outer conduit inlet and an outer conduit outlet. In some instances, the pressurized gas is provided from a pressurized canister, by a pump, or by any other suitable mechanism. Generally, providing pressurized gas to the inlet of the outer channel results in a high velocity gas being discharged from the outlet of the outer channel of the electrospray nozzle.

Any suitable gas pressure or gas velocity is optionally utilized in processes and/or systems herein. In specific embodiments, the gas pressure applied (e.g., to the inlet of the outer channel) is about 15 psi or more. In more specific embodiments, the gas pressure is about 20 psi or more, about 25 psi or more, about 35 psi or more, about 45 psi or more, or any other suitable pressure. In certain embodiments, the velocity of the gas at the nozzle (e.g., the outlet of the outer channel thereof) is about 0.5 m/s or more, about 1 m/s or more, about 5 m/s or more, about 10 m/s or more, about 25 m/s or more. In more specific embodiments, the velocity is about 50 m/s or more. In still more specific embodiments, the velocity is about 100 m/s or more, e.g., about 200 m/s or more, or about 300 m/s. In certain embodiments, the gas is any suitable gas, such as comprising air, oxygen, nitrogen, argon, hydrogen, or a combination thereof.

In certain embodiments, the inner and outer conduits have any suitable diameter. In some embodiments, the diameter of the outer conduit is about 0.1 mm to about 10 mm, e.g., about 1 mm to about 10 mm. In more specific embodiments, the diameter of the outer conduit is about 0.1 mm to about 5 mm, e.g., about 1 mm to about 3 mm. In certain embodiments, the diameter of the inner conduit is about 0.01 mm to about 8 mm, e.g., about 0.5 mm to about 5 mm, e.g., about 1 mm to about 4 mm. In systems using V_{AC}, even larger diameters (e.g., with inner diameters of up to 2.5 cm, or more, with outer diameters being about 1.05 times or more of the inner diameter, about 1.1 times or more of the inner diameter, or the like) are optionally utilized. Generally, as discussed herein, the inner conduit is configured inside the outer conduit, preferably along an identical axis, but slight offset and/or segmented configurations (e.g., a segmented outer conduit) are also considered to be within the scope of the instant disclosure. In some embodiments, an outer wall surrounds the outer conduit, the outer wall having an interior surface (e.g., defining the outer conduit). In some embodiments, the average distance between the exterior surface of the inner wall and the interior surface of the outer wall (referred to herein as the conduit gap) is any suitable distance. In specific instances, the conduit gap is about 0.1 mm or more, e.g., about 0.5 mm or more, or about 1 mm or more. In certain embodiments, the gap is small enough to facilitate a high velocity gas at the nozzle and to facilitate sufficient disruption of the charged fluid (jet) ejected from the nozzle (e.g., such as to provide sufficiently small droplet sizes and sufficiently uniform inclusion dispersion in the plume and on the collection substrate). In some embodiments, the conduit gap is about 0.01 mm to about 30 mm, such as about 0.05 mm to about 20 mm, about 0.1 mm to about 10 mm, or the like. In more specific embodiments, the conduit gap is about 0.5 mm to about 5 mm. In some embodiments, the inner conduit and the outer conduit run along an identical or similar longitudinal axis, the length of which both the inner and outer conduit running along that axis being the conduit overlap length. In some embodiments, the inner conduit length, the outer conduit length, and the conduit overlap length is about 0.1 mm or more, e.g., about 0.1 mm to about 100 mm, or more. In specific embodiments, the inner conduit length, the outer conduit length, and the conduit overlap length is about 0.5 mm to about 100 mm, e.g., about 1 mm to about 100 mm, about 1 mm to about 50 mm, about 1 mm to about 20 mm, or the like. In certain embodiments, the ratio of the conduit overlap length to the first diameter being about 1 to about 100 (e.g., about 10), or about 0.1 to about 10, e.g., about 0.1 to about 5 or about 1 to about 10. In some embodiments, the inner conduit is longer than the outer conduit, the inner conduit protruding beyond the outer conduit, e.g., as illustrated in FIG. 8. In some embodiments, the protrusion length is about −0.5 mm to about 1.5 mm, e.g., about 0 mm to about 1.5 mm, or about 0 mm.

In certain embodiments, processes herein comprise collecting and/or systems herein are configured to collect small particles and/or droplets of the plume onto a substrate. In specific embodiments, collection of these small particles/droplets allows for the formation of a uniform deposition on the substrate. Further, given the small size of the particles and/or droplets formed by systems and processes described herein, it is possible to form depositions having thin and/or uniform layers, and to have good control of the thickness thereof. In some embodiments, the substrate is positioned opposite the outlet of the nozzle.

In certain embodiment, processes provided herein comprise collecting a first composition (e.g., a deposition or film (e.g., a film being a layer of material, such as prepared by a deposition technique described herein) resulting from the electrospraying of a first fluid stock as described herein) on a substrate (e.g., metal foil), and collecting a second composition (e.g., resulting from electrospraying of a second fluid stock as described herein) on the first composition. In specific embodiments, the first composition or deposition, or combination of first and second composition (e.g., a precursor for an electrode or electrode material described herein) comprises a plurality of active electrode material (e.g., silicon) containing particles and a plurality of carbon inclusions (e.g., (first) graphene components), such as described in the fluid stock herein. In certain embodiments, the fluid of the fluid stock(s) is partially or completely removed (e.g., by evaporation during the electrospray process). In certain embodiments, the composition(s) or deposition(s), or combination of first and second compositions comprise a plurality of the active electrode containing inclusions (e.g., SiOx particles, such as microparticles described herein) secured within a carbonaceous web, such as a graphenic web comprising a plurality of graphenic components.

Any suitable substrate is optionally utilized. In some instances, the substrate is a grounded substrate or positioned between a plume generating nozzle and a grounded surface. In certain embodiments, the substrate has a surface that is positioned in opposing relation to a plume generating nozzle outlet (e.g., there is “line of sight” between the nozzle outlet and the substrate surface). In specific embodiments, the opposing substrate is directly opposing the nozzle (e.g., configured orthogonal to nozzle conduit configuration, such as illustrated in FIG. 2). In other specific embodiments, the opposing substrate is angled or offset from directly opposing the nozzle. In some embodiments, the substrate is affixed to or is a part of a conveyor system. In specific embodiments, the substrate is attached to a conveyor belt or is a part of a conveyor belt. In some instances, the substrate is a metal (e.g., a foil, such as of copper, aluminum, or the like) or other current collector type material (e.g., wherein a process herein is utilized to manufacture an anode material directly on a current collector), or on a substrate from which the electrode material is readily removed (e.g., wherein a process herein is utilized to manufacture anode powder materials).

In some embodiments, processes provided herein further comprise chemically and/or thermally treating a collected composition (e.g., such as to at least partially de-oxygenate the highly oxygenated first graphene component (e.g., graphene oxide)), or otherwise subjecting the collected composition to reductive conditions (e.g., suitable to reduce an oxygenated graphenic component). In certain embodiments, a process described herein comprises thermally treating (e.g., to at least 100° C.) a collected composition to provide a treated composition. In specific embodiments, the treated composition comprises a plurality of active electrode material (e.g., silicon) containing particles and a plurality of carbon inclusions (e.g., (second) graphene components), wherein the carbon inclusions of the treated composition comprise a greater weight percentage of carbon and a lower weight percentage of oxygen than do the carbon inclusions of the fluid stock. In certain embodiments, the carbon inclusions of the treated composition are oxidized graphene components that have been reduced. In specific embodiments, the carbon inclusions (e.g., treated graphene components) of the (e.g., thermally) treated composition comprise about 90 wt. % or more carbon and about 0.1 wt.

° A to about 10 wt. % oxygen. In certain embodiments, chemical and/or thermal treatment is optionally performed while the collected composition is on the substrate, or after removal of the collected composition from the substrate. In certain embodiments, the first (active electrode material containing or base) composition is treated prior to or following deposition of the second (or top, e.g., non-active electrode or silicon material containing) composition thereon. In some embodiments, a film comprising both the first and second composition is treated.

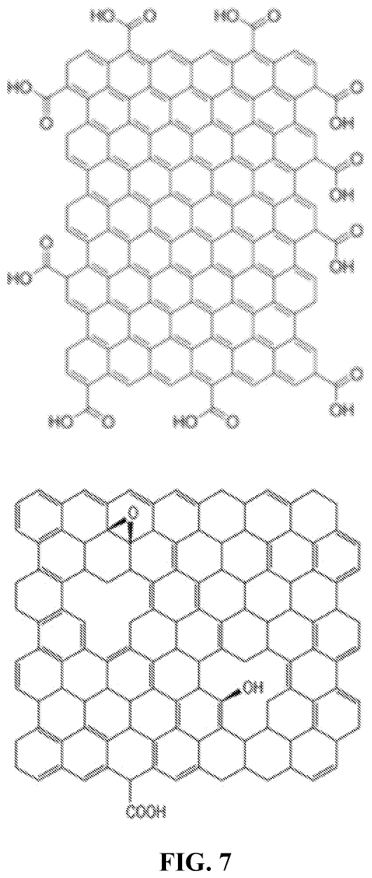

In specific embodiments, a process herein comprises a step of reducing the graphene component (e.g., decreasing the oxygen content thereof). In some embodiments, a process herein comprises thermally or chemically or otherwise reducing the graphene component. In certain embodiments, the reduced graphene component is a reduced graphene oxide. In some embodiments, the reduced graphene component or reduced graphene oxide is a graphene (pristine or defective, such as comprising one or more opened internal rings, or the like) that is optionally functionalized with oxygen, such as described for graphene oxides (e.g., wherein the oxygen wt. % is less than the oxygen wt. % of the graphene component of the fluid stock). Generally, reduced graphene component (e.g., reduced graphene oxide (rGO)) is recognized as a graphene oxide material that has been partially or wholly reduced, such as by thermal (e.g., heating, such as to 200° C. or more, such as under inert (e.g., nitrogen, argon, etc. atmosphere) or reductive conditions (e.g., hydrogen gas, mixed inert and hydrogen gas, or the like)), irradiation, chemical (e.g., by treating with hydrazine, hydrogen plasma, urea, or the like), or other (e.g., using strong pulse light) mechanisms. FIG. 7 illustrates various exemplary reduced graphene oxide (rGO) structures. As illustrated, the structure may have a basic two dimensional honeycomb lattice structure of graphene, with (or without) defects and with (or without) other atoms present (e.g., hydrogen and/or oxygen, including, e.g., oxidized structures, such as discussed and illustrated herein). In various embodiments, the reduced graphene component or reduced graphene oxide comprises about 60% or more carbon (e.g., 60% to 99%), such as about 70 wt. % or greater, about 75 wt. % or more, about 80 wt. % or greater, about 85 wt. % or greater, about 90 wt. % or greater, or about 95 wt. % or greater (e.g., up to about 99 wt. % or more). In certain embodiments, the reduced graphene component (e.g., rGO) comprises about 35 wt. % or less (e.g., 0.1 wt. % to 35 wt. %) oxygen, e.g., about 25 wt. % or less (e.g., 0.1 wt. % to 25 wt. %) oxygen, or about, about 20 wt. % or less, about 15 wt. % or less, about 10 wt. % or less (e.g., down to about 0.01 wt. %, down to about 0.1 wt. %, down to about 1 wt. % or the like) oxygen.

In specific embodiments, the reduced graphene component (e.g., rGO) comprises about 0.1 wt. % to about 10 wt. % oxygen, e.g., about 4 wt. % to about 9 wt. %, about 5 wt, % to about 8 wt, %, or the like. In some embodiments, the total percentage of carbon and oxygen does not constitute 100% of the reduced graphene component, with the additional mass comprising any suitable atoms, such as hydrogen, or other agents, as discussed for the non-reduced graphene components herein.

In specific embodiments, a graphene component (e.g., graphene oxide) is utilized in the fluid stock and, following electrospraying of the fluid stock, the collected deposition is thermally treated (e.g., to a temperature of about 100° C. or more, e.g., about 150° C. to about 350° C., about 200° C. to about 300° C., about 200° C., about 250° C., or any suitable temperature), such as to at least partially reduce the graphene oxide (i.e., decrease the percentage of oxygen relative to carbon in the graphene oxide). In some embodiments, thermal treatment of the graphene web shrinks the graphene web around the particles enclosed within the graphene pocket. In some embodiments, the shrunk web further protects the particles therewithin (e.g., by further minimizing electrolyte interaction with the particle), such as by reducing or minimizing the space within the envelope in which electrolyte can be trapped. In certain embodiments, the pocket, such as the shrunk pocket, retains its flexibility, allowing the particles to expand (e.g., up to at least 200% the original volume, at least 300% the original volume, at least 400% the original volume, or the like), such as within the pocket (e.g., allowing the particles to expand without becoming unnecessarily exposed to electrolyte, which can react with silicon to form a detrimental SEI layer when the silicon is lithiated). In some embodiments, the void space volume (volume within envelope not taken up by particles therewithin) within the shrunk pocket is reduced (e.g., relative to the pre-thermally treated envelope) by at least 10%, at least 20%, at least 30%, at least 50%, or the like following thermal treatment of the web. In certain embodiments, the void space volume within the pocket is any suitable volume, such as less than 100%, less than 50%, less than 25%, less than 10%, or the like of the volume of the particles therein. In various other embodiments, any other suitable technique is optionally utilized to reduce the graphene oxide following deposition. In some instances, reduction of the graphene oxide following deposition improve the performance characteristics of the material (e.g., by, in some instances, increasing conductivity of the carbon inclusion). For example, various figures provided herein illustrate that in some instances, materials provided herein demonstrate improved performance (e.g., specific capacity) characteristics with reduced graphene oxide (rGO), relative to graphene oxide (GO). However, in some instances, such as wherein water is utilized as the liquid medium of the fluid stock, it is preferred to utilize graphene oxide (GO), e.g., for its improved solubility/dispersability and facility in processing. In some embodiments, processes herein omit the reduction steps, such as wherein a graphene component suitable for an electrode material is utilized directly in the fluid stock.

In certain embodiments, an electrospray process described herein is a gas assisted or gas controlled electrospray process. In some embodiments, a fluid stock provided herein is electrosprayed with a gas stream. In specific embodiments, a fluid stock described herein is injected into a gas stream during electrospraying. In some embodiments, a process of producing of an electrostatically charged plume from a fluid stock further comprises providing a pressurized gas to a second inlet of a second conduit of a nozzle described herein. In specific embodiments, the second conduit has a second inlet and a second outlet, and at least a portion of the first conduit being positioned inside the second conduit (i.e., at least a portion of the second conduit being positioned in surrounding relation to the first conduit). In certain embodiments, the gap between the outer wall of the inner conduit and the inner wall of the outer conduit is small enough to facilitate a high velocity gas at the nozzle, such as to facilitate sufficient disruption of the charged fluid (jet) ejected from the nozzle (e.g., such as to provide plume or aerosol dispersions described herein). In some embodiments, the conduit gap is about 0.01 mm to about 30 mm, such as about 0.05 mm to about 20 mm, about 0.1 mm to about 10 mm, or the like. In certain embodiments, the gas stream (e.g., at the second outlet) has a high velocity, such as a velocity of at least 1 m/s, e.g., at least 5 m/s, at least 10 m/s, at least 20 m/s, or more.

In some instances, a process provided herein comprises compressing of a collected and/or (e.g., thermally) treated composition or film described herein. In certain embodiments, a collected and/or (e.g., thermally) treated composition or film is compressed such as to provide a compressed composition having a density of about 0.4 g per cubic centimeter (g/cc) or greater, such as about 0.5 g/cc or greater, or about 0.5 g/cc to about 2 g/cc (e.g., 0.7 g/cc to 2 g/cc) (e.g., about 1 g/cm³ or more, about 1.5 g/cm³ or more, or the like). In various embodiments, a collected, (e.g., thermally) treated, and/or compressed composition or film has a thickness of about 1 mm or less, or about 200 micron or less (e.g., on the substrate). In certain embodiments, a process provided herein further comprises compressing (e.g., calendering or otherwise compressing) a film or deposition provided herein. In certain embodiments, compression of the deposition provides increased electrode density and/or a thinner electrode, which, in some instances, provides improved volumetric energy density of the electrode. In certain embodiments, the volumetric energy density of the electrode is improved by at least 1.1 times, e.g., about 1.2× or more, about 1.25× or more, or about 1.5× or more, such as up to about 2× or more. In certain embodiments, volumetric energy density (of the anode) provided herein is about 500 mAh/cubic cm (cc) or more, such as about 750 mAh/cc or more, about 1000 mAh/cc or more, or the like. In specific embodiments, such a compression step is utilized when electrode active material (e.g., comprising SiOx) structures are micron scale (e.g., that is about 1 micron or greater, such as about 2 micron or greater, or about 2 micron to about 100 micron, or as otherwise described herein) dimension (or, e.g., an average dimension). In certain instances, compression of electrode materials comprising active electrode materials of the micron scale are particularly useful in increasing density of the material as the micron scaled structures can leave larger voids during deposition (e.g., relative to nanoscaled structures). In some embodiments, the film or deposition is compressed to a thickness about 90% or less, about 80% or less, about 70% or less, about 60% or less, or about 50% or less of the pre-compressed deposition thickness.

In some embodiments, provided herein is a process for manufacturing an electrode (or electrode material), the electrode comprising (a) an inclusion (e.g., micro- and/or nano-structured) comprising an active material (e.g., electrode active material, such as silicon) and (b) a (e.g., multi-layered) graphenic component. In specific embodiments, the process comprises producing a first and second electrostatically charged plume comprising a plurality of (e.g., micro- and/or nano-scale) particles and/or droplets from a first and a second fluid stock, such as described herein. In certain embodiments, such plumes are prepared by providing a fluid stock to an inlet of a conduit of an electrospray nozzle (e.g., and applying a voltage to the electrospray nozzle). In specific embodiments, the process comprises applying a voltage to the nozzle (e.g., wall of the conduit). In more specific embodiments, the voltage provides an electric field (e.g., at an outlet of the nozzle conduit, such as to expel the fluid stock as a jet and/or plume from the nozzle, e.g., outlet thereof). In some embodiments, the conduit is enclosed along the length of the conduit by a wall having an interior surface and an exterior surface, the conduit having an outlet. In some embodiments, a fluid stock comprising a (e.g., micro- o rnanostructured) inclusion comprising an active material (e.g., an electrode active material), a (e.g., multi-layered) graphenic component, and a liquid medium (e.g., water). In some embodiments, a second fluid stock comprises a graphenic component. In some embodiments, the process further comprises collecting a first and second deposition, composition or layer (e.g., collectively as a film) on a substrate (e.g., a conducting substrate, such as a current collector described herein). In certain embodiments, the film comprises (a) an inclusion comprising an active material and (b) a graphenic component (e.g., a graphenic web, such as securing (e.g., wrapping, trapping, and/or enveloping) the inclusion materials (e.g., nanostructured inclusion materials) comprising the active material therein). In further embodiments, the film comprises a top coat comprising a graphenic component, such as described herein, the topcoat being free or substantially free (e.g., less than 10 wt. %, less than 5 wt. %, less than 2 wt. % or the like) of the active (e.g., silicon-containing) material.

As discussed herein, processes and systems described herein allow for good control of the thickness of films or depositions provided for and described herein. In some embodiments, a film or deposition provided herein is a thin layer film or deposition, e.g., having an average thickness of about 1 mm or less, e.g., about 1 micron to about 1 mm. In specific embodiments, the deposition has a thickness of about 500 micron or less, e.g., about 1 micron to about 500 micron, about 1 micron to about 250 micron, or about 10 micron to about 200 micron, about 20 micron or less, about 0.5 micron to about 20 micron, or the like. Further, the processes and systems described herein not only allow for the manufacture of thin layer depositions, but of highly uniform thin layer films or depositions. In some embodiments, the films or depositions provided herein have an average thickness, wherein the thickness variation is less than 50% of the average thickness, e.g., less than 30% of the average thickness, or less than 20% of the average thickness.

In certain embodiments, the substrate is any suitable substrate (e.g., a grounded substrate, or a substrate located between the electrospray nozzle and a grounded plate). In some embodiments, such as wherein an electrode material is manufactured directly on a current collector, the substrate is a current collector material (e.g., a metal, such as copper or aluminum, foil or sheet). In such cases, any reductive (e.g., thermal reductive) treatment is optionally performed without removing the deposited material from the substrate. In some embodiments, provided herein are compositions or electrodes comprising an electrode material, or precursor thereof, and a substrate, such as described herein (e.g., a conductive substrate, such as a metal—e.g., an aluminum or copper foil).

A fluid stock (e.g., for electrospraying) provided herein comprises any suitable components. In specific embodiments, the fluid stock comprises a liquid medium and one or more inclusion component. In specific embodiments, a fluid stock for forming a (e.g., base coat) composition comprises a liquid medium, an active electrode material, or a precursor thereof, and a graphene component). In some embodiments, a fluid stock for forming a top coat comprises a liquid medium, and a graphenic component (e.g., substantially free of non-graphenic and graphitic active material (e.g., less than 10 wt. %, less than 5 wt. %, less than 2 wt. % or the like). Other additional inclusion materials are optionally included in either or both fluid stock.

In some embodiments, any suitable fluid stock is utilized in a process provided herein. In specific embodiments, an active-electrode material containing fluid stock comprises less than 30 wt. % active electrode material (e.g., silicon) containing particles. In more specific embodiments, the fluid stock comprises less than 20 wt. % active electrode material (e.g., silicon) containing particles. In still more specific embodiments, the first fluid stock comprises about 0.2 wt. % to about 10 wt. % active electrode material (e.g., silicon) containing particles. In some instances, such as wherein electrospray processes occur with a gas stream, higher loading of particles and/or graphenic component are possible. In certain embodiments, the active-electrode material containing fluid stock comprises about 1 wt. % or more (e.g., about 2.0 wt. % or more) active electrode material (e.g., silicon, such as SiOx) containing particles. In specific embodiments, the fluid stock comprises about 5 wt. % or more active electrode material (e.g., silicon) containing particles. In more specific embodiments, the active-electrode material containing fluid stock comprises about 5 wt. % to about 20 wt. % active electrode material (e.g., silicon) containing particles. In further or alternative embodiments, the weight ratio of active electrode material (e.g., silicon) containing particles to graphene components in the active-electrode material containing fluid stock or other composition (e.g., first layer, composition, or film) herein (e.g., collected and/or thermally treated films or first compositions, domains, or layers) is at least 1:10, e.g., at least 1:5, at least 1:3, at least 1:2, at least 2:3, at least 1:1, at least 3:2, or at least 2:1 (e.g., up to 10:1 or up to 20:1). In specific embodiments, the weight ratio of active electrode material (e.g., silicon) containing particles to graphene components is about 1:10 to about 10:1, about 1:3 to about 5:1, about 1:2 to about 3:1, about 2:3 to about 2:1, or the like (e.g., in a base composition, overall film, and/or (e.g., base) fluid stock herein). In more specific embodiments, the ratio is at least 2:3, at least 1:1, or the like. In certain embodiments, at least 50 wt. % of the solid particulates included in the fluid stock comprise active electrode material particulate inclusions and graphenic component. In specific embodiments, at least 70 wt. %, at least 80 wt. %, at least 90 wt %, or the like of the solid particulates included in the active-electrode material containing fluid stock comprise active electrode material particulate inclusions and graphenic inclusions. In preferred embodiments, at least 95 wt. % of the solid particulates included in the first fluid stock comprise active electrode material particulate inclusions and graphenic inclusions. In certain embodiments, similar or identical ratios of active material to carbon inclusion are provided herein for the materials and electrodes described herein, though in some instances wherein the carbon inclusion material (e.g., graphene component) is reduced, higher ratios are also contemplated for electrodes and electrode materials herein due to the weight loss resulting from the reduction process (e.g., due to the removal of oxygen from the carbon inclusion material). In preferred embodiments, higher ratios of active material to carbon material are preferred in order to improve the capacity of the resultant electrode materials, while not increased to such an extent so as to overly diminish cell cycling performance (e.g., by providing an insufficient amount of carbon inclusion material to sufficiently protect the active electrode material, such as from SEI formation, pulverization, or the like, and/or reduce electrode conductivity).

Carbon inclusions (e.g., graphene components) and active material (or precursors thereof) are included in the fluid stock(s) in any suitable concentration. In general, concentrations are preferred that increase or maximize throughput capabilities, while avoiding clogging the nozzle systems and/or causing unwanted aggregation, clumping, etc. of inclusion materials. In some embodiments, graphene components are included in the fluid stock in an amount sufficiently low to allow good dispersion and unpacking of the graphene sheets (e.g., to reduce or minimize folding of the graphene sheets onto one another). In certain embodiments, either fluid stock independently comprises about 0.01 wt. % or more graphene component, such as graphene oxide (GO). In certain embodiments, the base coat fluid stock comprises about 0.01 wt. % or more active material (e.g., silicon-containing (e.g., SiOx) particles). In more specific embodiments, either fluid stock independently comprises about 0.1 wt. % to about 10 wt. % graphene component, such as GO. In some embodiments, either fluid stock independently comprises about 1 wt. % to about 5 wt. % graphene component, such as GO. In more specific embodiments, the base coat fluid stock comprises about 0.1 wt. % to about 30 wt. % active material (e.g., silicon-containing particles). In some embodiments, the base coat fluid stock comprises about 0.2 wt. % to about 20 wt. % (e.g., about 0.2 wt. % to about 10 wt. %) active material (e.g., silicon-containing particles). In some embodiments, the base coat fluid stock comprises about 1 wt. % to about 15 wt. % (e.g., about 5 wt. % to about 10 wt. %) active material (e.g., silicon-containing particles). In specific embodiments, the concentration of the electrode active material and/or inclusions comprising the electrode active material (e.g., individually or in combination) provided in the fluid stock is about 0.05 wt % or more, e.g., about 0.1 wt % to about 25 wt %, about 0.2 wt % to about 10 wt %, about 0.5 wt % to about 5 wt %, about 1 wt % to about 3 wt %, about 2 wt %, or the like).

In some instances, if the amount of the graphene component in the (dispersed) solution is too small, the nanostructured inclusions (e.g., silicon active material) cannot be effectively wrapped with the carbon web comprising the graphene component in the electrode or electrode material. Thus, in some of such instances, the properties of the electrode can deteriorate. In some instances, gas-driven systems and processes described herein allow for the production of an aerosol or plume that has enough carbon (e.g., graphene) component to facilitate good formation of protected electrode materials (e.g., SiOx) that would not be possible using conventional techniques.

In some embodiments, the fluid stock has any suitable viscosity. In addition, the process and systems described herein allow for the electrospray manufacture of depositions using highly viscous (and, e.g., highly loaded) fluid stocks, if desired. For example, in some embodiments, fluid stocks utilized in systems and processes herein have a viscosity of about 0.5 centipoise (cP) or more, e.g., about 5 cP or more, or about 1 cP to about 10 Poise. In more specific embodiments, the viscosity is about 10 cP to about 10 Poise. In certain embodiments, the viscosity of the fluid stocks is independently (i.e., the fluid stock viscosities are the same or different, such as within the parameters provided) at least 200 centipoise (cP), such as at least 500 cP, at least 1000 cP, at least 2000 cP, at least 2,500 cP, at least 3,000 cP, at least 4,000 cP, or the like (e.g., up to 20,000 cP, up to about 10,000 cP, or the like). In preferred embodiments, the viscosity of the fluid stock is about 2,000 cP to about 10,000 cP.

In some embodiments, relatively small amounts of carbon inclusion are required to form a carbon web, securing the active material of the electrode material and/or electrode. In certain instances, such low carbon loading requirements, provide for very high capacities of the overall electrode, not just high capacities of the active material of the electrode. Further, with the inclusion of the carbon inclusion configured to secure the active material (e.g., to the current collector), the electrode comprises very high concentrations of active material and, e.g., does not require the use of additional binders (e.g., forming a binder-free electrode), fillers, or the like. In some instances, such high concentrations of active electrode material in the electrode and/or electrode material provided herein allows for the manufacture of electrodes having the desired capacities while using very little material. In some instances, processes provided herein are well designed to not only manufacture high capacity materials, but to also manufacture thin electrode materials having very good uniformity and very low defect characteristics (e.g., which defects may result in reduced capacity upon cycling).

In some embodiments, the carbon inclusion comprises about 20 wt % or less (e.g., about 10 wt % or less, about 5 wt % or less, or about 0.5 wt % to about 3 wt %) of the deposition, or about 20 wt % or less (e.g., about 10 wt % or less, about 5 wt % or less, or about 0.5 wt % to about 3 wt %) of the additives of the fluid stock (i.e., of the non-liquid medium components of the fluid stock).

In some embodiments, the weight ratio of inclusions (e.g., micro- and/or nano-structures) comprising active material to carbon inclusion (e.g., in a fluid stock, deposition, and/or material provided herein) is about 8:2 to about 999:1, e.g., about 85:15 to about 995:5, about 9:1 to about 99:1. In certain embodiments, the percentage of inclusions (e.g., micro- and/or nano-structures) comprising active material in the electrode or electrode material is about 25 wt % or more, e.g., about 50 wt % or more, about 75 wt % or more, about 80 wt % or more, about 85 wt % or more, about 90 wt % or more, about 95 wt % or more, or the like. Further, in some embodiments, the amount of active material in the electrode or electrode material is about 20 wt % or more, e.g., about 40 wt % or more, about 50 wt % or more, about 60 wt % or more, about 70 wt % or more, about 80 wt % or more, about 90 wt % or more, or the like.

In certain embodiments, the liquid medium comprises any suitable solvent or suspending agent. In some embodiments, the liquid medium is merely utilized as a vehicle and is ultimately removed, e.g., by evaporation during the electrospraying process and/or upon drying of the deposition. In some embodiments, the liquid medium is aqueous. In specific embodiments, the liquid medium comprises water, alcohol ((e.g., n-, tert-, sec-, or iso-) butanol, (e.g., n-, or iso-) propanol, ethanol, methanol, or combinations thereof), tetrahydrofuran (THF), dimethylformamide (DMF), N-methyl-2-pyrrolidone (NMP), Dimethylacetamide (DMAc), or combinations thereof. In more specific embodiments, the liquid medium comprises water.

Further, in some embodiments, it is desirable that any additives in the fluid stock are dissolved and/or well dispersed prior to electrospray, e.g., in order to minimize clogging of the electrospray nozzle (and/or other system components), ensure good uniformity of dispersion of any inclusions in the resulting deposition, and/or the like. In specific embodiments, the fluid stock is agitated prior to being provided to the nozzle (e.g., inner conduit inlet thereof), or the system is configured to agitate a fluid stock prior to being provided to the nozzle (e.g., by providing a mechanical stirrer or sonication system associated with a fluid stock reservoir, e.g., which is fluidly connected to the inlet of the inner conduit of an electrospray nozzle provided herein).

Any suitable active electrode material or silicon inclusion material is optionally utilized in electrodes, films, compositions, domains, fluid stocks, aerosols, precursors, or the like described herein. In certain embodiments, the active electrode material comprises a high energy capacity material (e.g., having a theoretical capacity of greater than graphite, such as >400 mAh/g, >500 mAh/g, >750 mAh/g, >1,000 mAh/g, or more). In specific embodiments, the active electrode material is not graphite (non-graphitic). In some embodiments, the active electrode material comprises a material having high volume expansion upon lithiation (e.g., >150%, or >200%). In some instances, the active electrode material comprises Si, Ge, Sn, Co, Cu, Fe, any oxidation state thereof, or any combination thereof. In certain embodiments, the anode or high energy capacity material comprises Si, Ge, Sn, Al, an oxide thereof, a carbide thereof, or an alloy thereof. In specific embodiments, the anode or high energy capacity material comprises SiOx (e.g., wherein 0≤x≤2, or 0<x<1.5), SiOₐN_{b}C_{c} (e.g., wherein 0≤a≤2, 0≤b≤4/3, and 0≤c≤1, and, e.g., wherein a/2+3b/4+c is about 1 or less), Sn, SnOx (e.g., wherein 0≤x≤2, or 0<x<1.5), Si, Al, Ge, or an Si alloy.

Generally, silicon inclusion materials comprise an active silicon electrode material (e.g., Si, SiOx, or the like) or a precursor thereof. In certain embodiments, the silicon material comprises a plurality of structures comprising a silicon material. In specific embodiments, the silicon material is a silicon material that is active in an electrode, such as a negative electrode in a lithium ion battery. In more specific embodiments, the silicon material is, by way of non-limiting example, elemental silicon, and/or a silicon oxide (e.g., having a formula: SiOx, wherein 0≤x<2, e.g., 0≤x≤1.5, or 0<x<1). In specific embodiments, x is 0 to about 1.5. Any suitable inclusion structure is optionally utilized, such as a fiber, particle, sheet, rod, and/or the like.

Generally, the silicon-containing inclusion structures are micron or submicron in size, such as nanoscaled structures. In certain embodiments, silicon-containing inclusions provided herein have an average dimension of less than 100 micron, such as less than 50 micron, or less than 30 micron. In more specific embodiments, the silicon-containing inclusions have an average dimension of less than 25 micron, less than 2 micron, less than 15 micron, less than 10 micron or the like. In certain embodiments, the silicon-containing inclusions have an average dimension of at least 200 nm, e.g., about 200 nm to about 10 micron. In other embodiments, nanostructured inclusions are preferred, such as having an average dimension of about 200 nm or less, such as about 10 nm to about 200 nm. In certain embodiments, silicon-containing inclusions have a high aspect ratio (length divided by width), such as being in a fiber or rod form, or a low aspect ratio, such as in a spherical form. In some embodiments, the silicon-containing inclusions have an average aspect ratio of about 1 to about 100, or more. In specific embodiments, the silicon-containing inclusions have an average aspect ratio of 1 to about 50, or 1 to about 20, or 1 to about 10. In some embodiments, such as wherein silicon containing inclusions have an aspect ratio of about 10 or greater, silicon-containing inclusions provided herein have at least one average dimension of less than 100 micron, such as less than 50 micron, or less than 30 micron. In more specific embodiments, the silicon-containing inclusions have an average dimension of less than 25 micron, less than 2 micron, less than 15 micron, less than 10 micron or the like. In certain embodiments, the silicon-containing inclusions have at least one average dimension of at least 200 nm, e.g., about 200 nm to about 10 micron. In other embodiments, the silicon-containing inclusions have at least one average dimension of about 200 nm or less, such as about 10 nm to about 200 nm (e.g., a high aspect ratio nanofiber or nanorod, wherein the nanofibers or nanorods have an average diameter of about 10 nm to about 200 nm and a length up to 10 times, up to 100 times, or more the diameter). In some instances, such as wherein larger structures are utilized, larger droplets are necessarily formed upon electrospray according to the processes described herein.

In certain embodiments, silicon-containing inclusions utilized herein further comprise an additional material (e.g., as a composite), such as carbon (e.g., amorphous and/or crystalline carbon). Silicon-containing inclusions described herein optionally comprise (e.g., on average) any suitable amount of active electrode silicon material (e.g., Si and/or SiOx), such as about 30 wt. % or more of active electrode silicon material, about 50 wt. % or more of active electrode silicon material, about 70 wt. % or more of active electrode silicon material, or the like.

In some embodiments, active electrode material containing inclusions or particles used in compositions, films, electrodes, processes, and the like herein comprise SiOx, wherein 0≤x≤2 (i.e., silicon and/or a silicon oxide (SiOx, wherein 0<x≤2)). In specific embodiments, the silicon-containing particles comprise a sub-stoichiometric silicon oxide (i.e., SiOx, wherein 0<x<2). In some embodiments, particles described herein as comprising SiOx may comprise both Si and silicon oxide, SiOa (0<a≤2), for an overall x value of 0<x<2, preferably 0<x≤0.5. Disclosures herein to inclusions comprising SiOx include reference to the overall x value of an inclusion (e.g., the inclusions may comprise both elemental silicon (Si) and substoichiometic and/or fully oxidized silicon oxide), unless noted otherwise. In specific embodiments, silicon-containing particles comprise (e.g., on average) about 50 wt % or more silicon (e.g., elemental silicon (Si)). In some embodiments, such particles also comprise SiOx (e.g., wherein 0<x≤2). In specific embodiments such particles comprise both Si and SiOx (e.g., with SiOx being present on the surface of the particles). In certain embodiments, silicon-containing particles comprise (e.g., on average) about 0.1 wt % to about 25 wt % (e.g., about 1 wt. % to about 10 wt. %) SiOx. In certain embodiments, the particles have an average dimension (e.g., overall average dimension) of about 10 nm or more, e.g., about 200 nm or more. In specific embodiments, the average dimension is about 200 nm (0.2 micron) to about 20 micron, e.g., about 1 to about 10 micron, about 0.5 micron to about 5 micron, or about 1 micron to about 5 micron. In certain embodiments, the particles have one or more dimension (e.g., length, width, diameter, length, smallest dimension, or the like) having an average size of about 10 nm or more, e.g., about 200 nm or more. In specific embodiments, the average dimension is about 200 nm (0.2 micron) to about 20 micron, e.g., about 1 to about 10 micron, about 0.5 micron to about 5 micron, or about 1 micron to about 5 micron. In some embodiments, particles have an average aspect ratio of 1 or more, such as 1 to about 100, 1 to about 10, or the like. In certain embodiments, the active electrode material containing (e.g., silicon-containing) particles have an average aspect ratio of 1 to about 100, such as 1 to about 10. In further or alternative embodiments, active electrode material containing (e.g., silicon-containing) particles have an average dimension (or an average smallest dimension) of about 10 microns or less, e.g., about 200 nm to about 10 micron, or about 1 micron to about 5 micron.

In specific embodiments, the active electrode material (e.g., silicon) containing particles provided herein have high roundness, low sphericity, and/or a small maximum size. In more specific embodiments, the particles have high roundness, low sphericity, and a small maximum size. In further embodiments, the particles have other beneficial characteristics, such as low standard deviation in size, and/or the like. In certain instances, when prepared into an electrode material herein, control of such characteristics improves control of swelling directionality during lithiation and de-lithiation and/or facilitates better coverage and/or protection of the particles during lithiation and de-lithiation, such as by reducing delamination of the particles during usage (e.g., battery cycling).

In specific embodiments, particles provided herein, as well as particles provided in compositions, electrodes, powders, liquid compositions, aerosols, and the like, and in processes herein are characterized by a number of characteristics. In some embodiments, as will be discussed herein, the particles characterized herein have a smallest dimension of less than 100 micron, less than 75 micron, less than 50 micron, less than 40 micron, less than 30 micron, less than 20 micron, less than 10 micron, or the like (e.g., down to about 0.05 micron, about 0.1 micron, about 0.2 micron, or the like). In further or additional embodiments, the particles a largest dimension of at least 0.1 micron, at least 0.2 micron, at least 0.3 micron, at least 0.5 micron, at least 1 micron, or the like. In certain embodiments, compositions and the like provided herein optionally comprise other particles outside of these ranges (particularly at the lower end), but such particles don't necessarily have the characteristics described herein. In certain embodiments, (e.g., non-precursor) particles provided herein have an average largest dimension of about 20 micron or less, such as about 15 micron or less, about 0.1 micron to about 10 micron, or about 0.2 micron to about 5 micron. In some embodiments, fewer than 3% (e.g., fewer than 1%, fewer than 0.5%, fewer than 0.2%, fewer than 0.1%) of the (e.g., non-precursor) particles have a largest dimension of greater than 20 micron. In specific embodiments, fewer than 3% (e.g., fewer than 1%, fewer than 0.5%, fewer than 0.2%, fewer than 0.1%) of the (e.g., non-precursor) particles have a largest dimension of greater than 15 micron. In more specific embodiments, fewer than 3% (e.g., fewer than 1%, fewer than 0.5%, fewer than 0.2%, fewer than 0.1%) of the (e.g., non-precursor) particles have a largest dimension of greater than 10 micron. In certain embodiments, less than 10 wt. % (e.g., less than 5 wt. %, less than 3 wt. %, less than 1 wt. % or the like) of the particles have a largest dimension of greater than 20 micron. In specific embodiments, less than 10 wt. % (e.g., less than 5 wt. %, less than 3 wt. %, less than 1 wt. % or the like) of the particles have a largest dimension of greater than 15 micron. In more specific embodiments, less than 10 wt. % (e.g., less than 5 wt. %, less than 3 wt. %, less than 1 wt. % or the like) of the particles have a largest dimension of greater than 10 micron.

In certain embodiments, the particles have an average roundness of about 0.2 or more. In specific embodiments, the particles have an average roundness of about 0.3 or more. In more specific embodiments, the particles have an average roundness of about 0.4 or more. In still more specific embodiments, the particles have an average roundness of about 0.5 or more. In yet more specific embodiments, the particles have an average roundness of about 0.6 or more. Roundness is determinated by a suitable measure available in the art, such as either one of the following:

$$Roundness ( R ) = \frac{4 \times A}{π \times L \times L}$$

$$Roundness ( R ) = \frac{{\sum }_{1}^{N} \frac{{r}_{i}}{N}}{{r}_{cir , m i n}}$$

A=Area

L=Length

rᵢ=radius of curvature at ith corner

N=total number of corners

r_{cir,min}=minimum circumscribable radius of a given particle

In some embodiments, the particles have an average sphericity of about 0.8 or less. In specific embodiments, the particles have an average sphericity of about 0.7 or less. In more specific embodiments, the particles have an average sphericity of about 0.6 or less. In still more specific embodiments, the particles have an average sphericity of about 0.5 or less. In yet more specific embodiments, the particles have an average sphericity of about 0.4 or less. In certain embodiments, the particles have an average aspect ratio of at least 1.1, of at least 1.2, of at least 1.3, of at least 1.5, of at least 2, or the like. Sphericitiy is determinated by a suitable measure available in the art, such as either one of the following:

$$Sphericity : S = \frac{4 π A}{{p}^{2}}$$

$$Sphericity : S = \frac{{r}_{i n , m ax}}{{r}_{cir , m i n}}$$

A=Area

p=perimeter

r_{cir,min}=minimum circumscribable radius of a given particle

r_{in,max}=maximum inscribable radius of a given particle

In certain embodiments, the particles have a standard deviation of the largest dimension thereof equal to about twice average largest dimension thereof or less (or, the coefficient of variance (CV), being the standard deviation (SD)/average, is equal to or less than about 2). In certain embodiments, the coefficient of variance is ≤1.5, ≤1.2, ≤1, ≤0.9, ≤0.8, or the like. In some embodiments, fewer than 50%, fewer than 40%, fewer than 30%, fewer than 20%, fewer than 10% or the like are caked (e.g., by number or by weight). In certain instances herein, caking of the particles occurs when aggregated domains form within a particle composition, such as wherein aggregated domains have a size of greater than 50 micron, greater than 40 micron, greater than 30 micron, greater than 20 micron, or the like (e.g., wherein the aggregate flows, such as with a bulk solid or powder of which it is a part, but the particles comprising the aggregate do not independently flow).

In some embodiments, an inclusion (e.g., in the fluid stock, droplets, and/or electrode or deposition) comprises a composite of an active electrode material. In specific embodiments, the inclusion further comprises a second material (e.g., carbon, ceramic, or the like). In some embodiments, the inclusions are nanoscale inclusions, such as nanofibers, nanorods, or nanoparticles. In specific embodiments, the inclusion is a composite (e.g., nanofiber) comprising carbon and a silicon material (e.g., having the formula SiOx, wherein 0≤x≤2, or other active silicon material, such as described herein). In certain embodiments, such materials are optionally manufactured according to any suitable technique, with exemplary techniques being described in U.S. patent application Ser. No. 14/382,423, entitled “Silicon Nanocomposite Nanofibers,” U.S. patent application Ser. No. 14/457,994, entitled “Carbon and Carbon Precursors in Nanofibers,” and U.S. Patent Application No. 62/111,908, entitled “Silicon-Carbon Nanostructured Composites,” all of which are incorporated herein for the disclosure of such materials and methods of manufacturing such materials. For example, in certain embodiments, nanostructures comprising electrode active material provided herein are manufactured by dispersing silicon nanoparticles (i.e., nanoparticles comprising silicon, and, in some instances, oxides thereof) in a fluid stock (e.g., with a polymer and liquid medium), electrospinning (e.g., gas-assisted electrospinning) the fluid stock, carbonizing the product (e.g., nanofibers) thereof. In some embodiments, the inclusion is a carbon nanostructure (e.g., a carbon nanotube or a hollow carbon nanofiber) infused with a silicon material described herein (e.g., silicon or an SiOx material described herein).

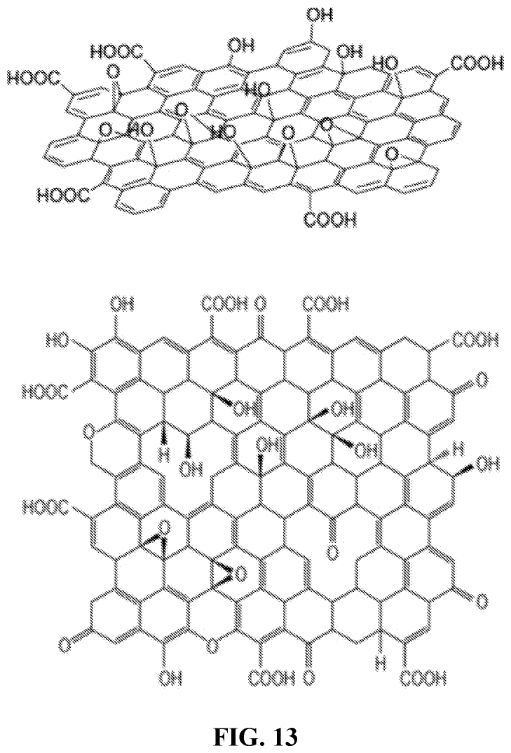

Any suitable graphenic component is utilized in the fluid stocks, compositions, films, and the like described herein. In certain embodiments, the carbon material is any suitable carbon material, such as a nanostructured carbon material. In some instances, the carbon material is a carbon sheet, a carbon ribbon, or the like. In some embodiments, the carbonaceous inclusions are graphenic components, such as graphene, graphene oxide, reduced graphene oxide, sheets thereof, ribbons thereof, or the like, or oxides, analogs or derivatives thereof, such as described herein. In specific embodiments, the carbon inclusion material is a graphene component, e.g., graphene or an analog there, such as graphene that has one or more carbon atom thereof substituted with one or more additional atom, such as oxygen, halide, hydrogen, and/or the like. Generally, graphene or graphenic components herein have a general two-dimensional structure (e.g., with at least 2 layers, such as at least 3 layers, at least 5 layers, about 5 layers to about 50 layers, about 5 layers to about 25 layers, or the like), with a honey-comb lattice structure (which in some instances, such as in non-pristine graphene, graphene oxide, reduced graphene oxide, or the like, may comprise certain defects therein, such as described and illustrated herein). In specific embodiments, the graphene component is an oxidized graphene component. In some instances, the carbon material is or comprises a graphene component, such as graphene, graphene oxide, reduced graphene oxide, or a combination thereof. In specific embodiments, the oxidized graphene component is a graphene component functionalized with oxygen, such as with carbonyl (C═O) groups, carboxyl groups (e.g., carboxylic acid groups, carboxylate groups, COOR groups, such as wherein R is a C1-C6 alkyl, or the like), —OH groups, epoxide groups, ether (—O—) groups, and/or the like. FIG. 13 illustrates an exemplary oxidized graphene component (graphene oxide) structure including COOH, OH, epoxide, ether, and carbonyl groups. Other graphene oxide structures are also contemplated herein. In certain embodiments, the oxidized graphene component (or graphene oxide) comprises about 60% or more carbon (e.g., 60% to 99%). In more specific embodiments, the oxidized graphene component comprises about 60 wt. % to about 90 wt. % carbon, or about 60 wt. % to about 80 wt. % carbon. In further or alternative specific embodiments, the oxidized graphene component comprises about 40 wt. % oxygen or less, such as about 10 wt. % oxygen to about 40 wt. % oxygen, about 35 wt. % oxygen or less, about 1 wt. % to 35 wt. % oxygen, or the like. In some preferred embodiments, the oxidized graphene component comprises sufficient oxygen so as to facilitate dispersion and opening of the graphene sheets in an aqueous medium. In some embodiments, the total percentage of carbon and oxygen does not constitute 100% of the graphene component or analog, with the additional mass comprising any suitable atoms, such as hydrogen (and/or, e.g., nitrogen (e.g., in the form of amine, alkyl amine, and/or the like). In addition, graphene components utilized in the processes and materials utilized herein optionally comprise pristine graphene sheets, or defective graphene sheets, such as wherein one or more internal and/or external rings are oxidized and/or opened, etc. In certain embodiments, a graphene oxide is utilized in the fluid stock and, following electrospraying of the fluid stock, the collected deposition is thermally treated (e.g., to a temperature of about 100° C. or more, e.g., 150° C. to 400° C., about 150° C. to about 350° C., about 200° C. to about 300° C., about 200° C., about 250° C., or any suitable temperature), such as to at least partially reduce the graphene oxide (i.e., decrease the percentage of oxygen relative to carbon in the graphene oxide). In various other embodiments, any other suitable technique is optionally utilized to reduce the graphene oxide following deposition. In some instances, reduction of the graphene oxide following deposition improve the performance characteristics of the material (e.g., by, in some instances, increasing conductivity of the carbon inclusion). For example, various figures provided herein illustrate that in some instances, materials provided herein demonstrate improved performance (e.g., specific capacity) characteristics with reduced graphene oxide (rGO), relative to graphene oxide (GO). However, in some instances, such as wherein water is utilized as the liquid medium of the fluid stock, it is preferred to utilize graphene oxide (GO), e.g., for its improved solubility/dispersability and facility in processing.

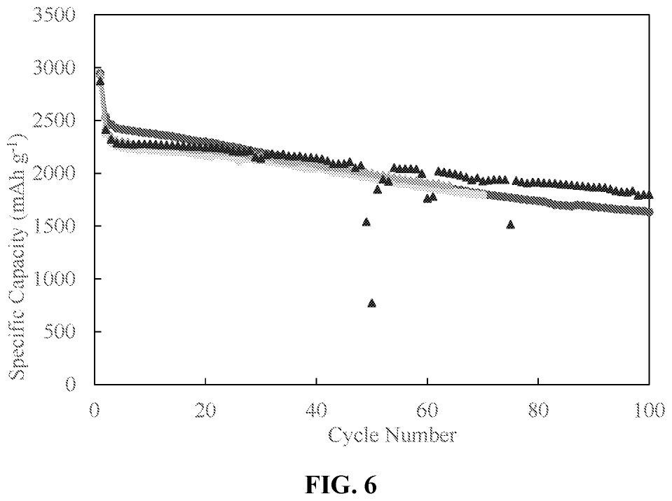

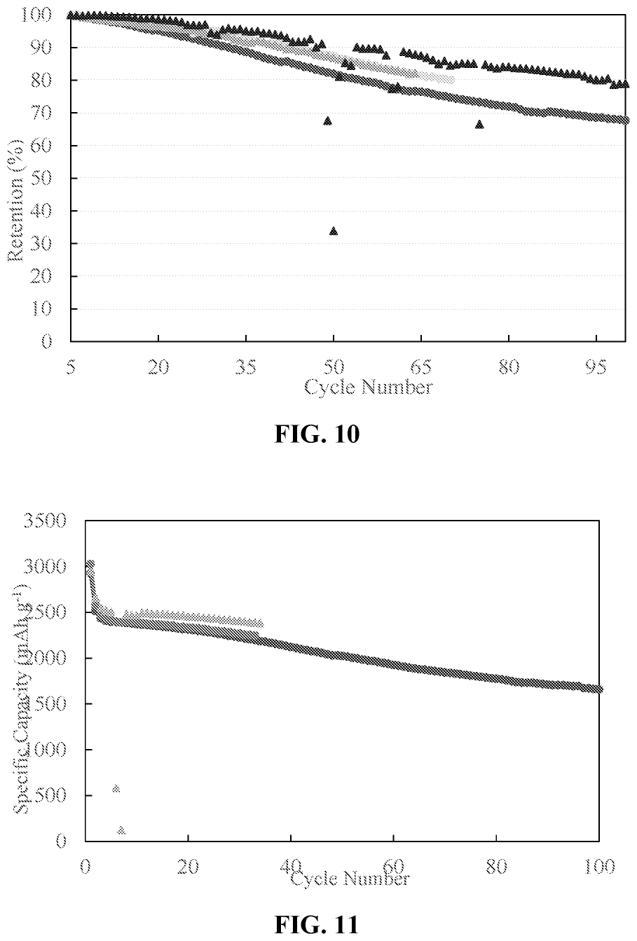

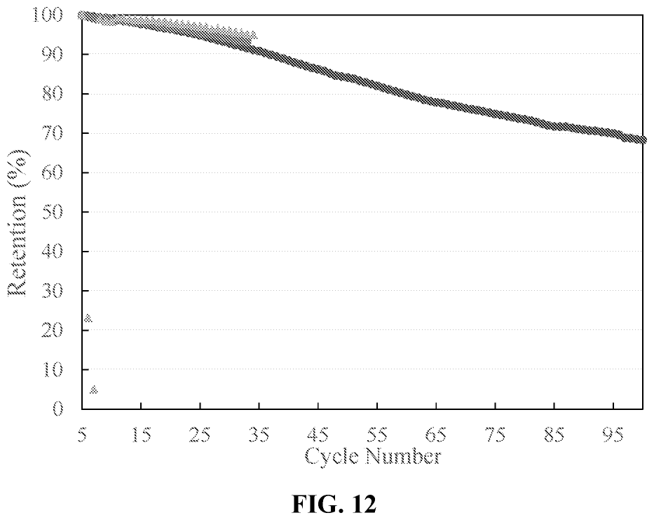

In certain embodiments, a multi-layered oxidized graphenic component (e.g., graphene oxide) material is utilized in a process of manufacturing an electrode, electrode material, or precursor thereof, as described herein. In some embodiments, a multi-layered graphenic component (e.g., reduced graphene oxide) material is utilized in an electrode, electrode material, or precursor thereof, such as afforded following a (e.g., thermal) reduction step described herein. In various embodiments, any suitable source of graphenic component is optionally utilized. In some embodiments, the graphenic component is derived from synthetic graphite or natural graphite (e.g., natural flake graphite). In many instances, battery chemistries often utilize synthetic graphite based materials because a high degree of purity is desired in battery chemistries. However, natural graphite is often much less expensive, which makes it an attractive target. As demonstrated in FIG. 6 and FIG. 10, anodes prepared using multi-layered graphene oxide derived from synthetic graphenic sources (or comprising multi-layered graphenic component) exhibit good capacities and capacity retentions, whereas FIG. 11 and FIG. 12 demonstrate that anodes prepared using multi-layered graphene oxide derived from natural (natural flake) graphenic sources (or comprising multi-layered graphenic component derived from natural graphene sources) also exhibit excellent capacity and capacity retention characteristics.

In certain embodiments, a graphene component utilized in fluid stocks and materials herein has any suitable dimension. In some embodiments, the carbon inclusion is a two dimensional material, such as a graphene component (e.g., graphene oxide, reduced graphene oxide, graphene, or the like). In certain embodiments, the two dimensional material (e.g, graphene component) has a first dimension and a second dimension (e.g., length and width), the average of which is the average dimension of the material. In some embodiments, active material inclusions have three dimensions (e.g., length, width, height for particles, or diameter and length for rods/fibers) having an average dimension. In some embodiments, graphenic component utilized are of a size sufficient to coat or wrap, such as in an envelope or web, the active material inclusions upon electrospray deposition. In specific embodiments, the average dimension of a (e.g., two dimensional) graphenic component is equal to or greater than the average dimension of the active material inclusions. In certain embodiments, larger graphenic component provide the ability to wrap or envelop multiple active material inclusions. In some embodiments, the average dimension of the graphenic component is about 0.1× to about 500× the average dimension of the active material inclusion. In specific embodiments, the average dimension of the graphenic component is about 1× to about 200× the average dimension of the active material inclusion. In more specific embodiments, the dimension of the graphenic component is about 5× to about 25×, such as about 10×, the average dimension of the active material inclusion (e.g., wherein the electrode active material inclusions have an average dimension of about 200 nm or more). In other specific embodiments, the dimension of the graphenic component is about 50× to about 250×, such as about 100×, the average dimension of the active material inclusion (e.g., wherein the electrode active material inclusions have an average dimension of about 200 nm or less). In some embodiments, the average dimension of a two-dimensional carbon inclusion is about 1 micron to about 20 micron (e.g., about 5 micron to about 10 micron).

In some embodiments, graphenic component (e.g., two-dimensional carbon inclusions, such as graphene components) of the films, electrodes, or first and/or second fluid stocks, compositions, domains, or the like provided herein have at least one average dimension (e.g., lateral dimension (longest side length), width and/or length) (that is, the measure of the dimension, on average, within the carbon inclusions of the processes or compositions provided herein) that is at least equal to the average dimension (or the average smallest dimension—particularly in instances where higher aspect ratio (e.g., >2, >5, >10, or the like) active electrode material containing particles are utilized) of the active electrode material containing (e.g., silicon-containing) particles. In specific embodiments, carbon inclusions provided herein have at least one average dimension that is >1× (e.g., >1.1×, >1.2×, >1.5×, >2×, >3×, >4×, or the like) the average dimension (or the average of the smallest dimension) of the active electrode material containing particles. In certain embodiments, graphenic component provided herein have at least one average dimension (e.g., width and/or length) that is at least five times (e.g., about 2 times to about 20 times, about 10 times, or about 100 times) the average dimension (or the average smallest dimension) of the active electrode material containing (e.g., silicon-containing) particles. In certain embodiments, the graphenic component have an average thickness of at least 1.5 nm, at least 2 nm, at least 3 nm, at least 5 nm, at least 10 nm, at least 15 nm, at least 20 nm, or the like. In certain embodiments, the thickness is about 100 nm (nanometer) or less, such as about 50 nm or less, or about 20 nm or less. In certain embodiments, a graphene components described herein comprises more than one layere (e.g., graphene component layers) thereof (e.g., each graphene layer comprising a graphene, graphene oxide, reduced graphene oxide, or the like). In specific embodiments, a graphene component provided herein comprises an average of about 5 to about 25 layers thereof. Similarly, in some embodiments, graphene envelopes described herein comprising such carbon inclusions or graphene components comprise such thicknesses and/or number of layers therein. In some embodiments, the carbon inclusion (e.g., two-dimensional carbon inclusions, such as graphene components) has an average dimension (e.g., lateral dimension, width and/or length) of about 0.5 micron or more, about 1 micron or more, about 5 micron or more, about 1 micron to about 100 micron, about 5 micron to about 50 micron, or the like.

In various embodiments, compositions (e.g., base compositions or domains), webs, envelopes, films, or the like (e.g., of compositions provided herein) comprise carbon inclusions (e.g., graphene component or oxidized graphene component) and particles (e.g., electrode active material, such as silicon) in a particle to carbon inclusion weight ratio of at least 1:5, e.g., at least 1:3, or at least 1:2. In specific embodiments, the carbon inclusion is an oxidized graphene component and the weight ratio of particles (e.g., comprising silicon) to oxidized graphene component (e.g., graphene oxide) is about 1:5 to about 5:1, e.g., about 1:1 to about 5:1, or about 1:1 to about 3:1. In specific embodiments, ratio of particles (e.g., comprising silicon) to oxidized graphene component (e.g., graphene oxide) is about 3:2 to about 5:1. In certain embodiments, compositions provided herein comprise 20 wt. % or more, about 30 wt. % or more, about 40 wt. % or more, about 50 wt. % or more, or the like of active electrode materials. In certain instances, pre-thermally treated compositions or films have lower wt. % that post-thermally treated compositions (e.g., because upon thermal treatment, the carbonaceous inclusion, such as graphene oxide, is reduced, losing oxygen and molecular weight and mass). In certain embodiments, up to about 80 wt %, up to about 85 wt. %, up to about 90 wt. %, up to about 95 wt. % or the like of active material is optionally included. In specific embodiments, pre-thermally treated compositions comprise about 30 wt. % to about 80 wt. % active electrode material (e.g., SiOx). In further or alternative embodiments, post-thermally treated compositions comprise about 50 wt. % to about 95 wt. % electrode active material (e.g., SiOx). In certain embodiments, compositions provided herein comprise 5 wt. % or more, about 10 wt. % or more, about 30 wt. % or more, or the like of carbon inclusion materials (e.g., graphenic component). In some embodiments, up to about 80 wt %, up to about 70 wt. %, up to about 50 wt. %, up to about 30 wt. % or the like of carbon inclusion materials (e.g., graphenic component) is optionally included. In specific embodiments, pre-thermally treated compositions comprise about 20 wt. % to about 80 wt. % carbon inclusion materials (e.g., graphenic component). In further or alternative embodiments, post-thermally treated compositions comprise about 10 wt. % to about 50 wt. % carbon inclusion materials (e.g., graphenic component).

In some embodiments, a composition or film provided herein comprises a plurality of active electrode material containing (e.g., silicon-containing) particles and a plurality of carbon inclusions (e.g., oxidized graphene components). In certain embodiments, a (e.g., pre- and/or post-thermally treated) composition or film provided herein comprises active electrode material containing particles secured within a graphenic web. In some embodiments, the web defines one or more pockets (e.g., graphenic pockets) within which one or more of the active electrode material containing particles are configured. In specific embodiments, the composition or film comprises a plurality of graphene envelopes, the graphene envelopes comprising an external surface and an internal surface, the internal surface defining a graphene pocket. In more specific embodiments, one or more of the active electrode material containing (e.g., silicon-containing) particles are configured within the graphene pocket. In certain embodiments, the graphene envelopes comprise one or more of the carbon inclusions of a (e.g., first or base) composition or layer (e.g., oxidized graphene component(s)). In specific embodiments, a graphene pocket(s) comprise at least 1 active electrode containing particle configured therewithin (e.g., on average). In more specific embodiments, a graphene pocket comprises, on average, greater than 1 (e.g., at least 1.05) active electrode containing particles configured therewithin. In some embodiments, a graphene pocket(s) comprise 1 to 200 or 1 to 100 active electrode material containing (e.g., silicon-containing) particles configured therewithin (e.g., 1<n≤100, 1.01≤n≤200, 1.05≤n≤100, or the like wherein n is the number of active electrode containing particles configured within the envelope) (e.g., on average). In more specific embodiments, the graphene pocket(s) comprise 1-50 (e.g., 1-5, or 2-5) (e.g., 1<n≤50, 1<n≤5, 2≤n≤5) active electrode material containing (e.g., silicon-containing) particles configured therewithin (e.g., on average).

In some embodiments, a (e.g., thermally) treated composition or film comprises a plurality of active electrode material containing (e.g., silicon-containing) particles and a plurality of carbon inclusions (e.g., oxidized graphene components that have been (e.g., thermally) reduced). In certain embodiments, a composition or film (e.g., pre- and/or post-thermally treated composition or film) provided herein comprises active electrode material containing particles secured within a carbonaceous web (e.g., graphenic web). In some embodiments, the web defines one or more pockets (e.g., graphenic pockets) within which one or more of the active electrode material containing particles are configured. In specific embodiments, the (e.g., thermally) treated composition or film comprises a plurality of graphene envelopes, the graphene envelopes comprising an external surface and an internal surface, the internal surface defining a graphene pocket. In more specific embodiments, one or more of the active electrode material containing (e.g., silicon-containing) particles are configured within the graphene pocket. In certain embodiments, the graphene envelopes or pocket walls comprise one or more of the carbon inclusions of the treated composition or film (e.g., oxidized graphene component(s) that have been (e.g., thermally) reduced). In specific embodiments, a graphene pocket(s) comprise 1-100 active electrode material containing (e.g., silicon-containing) particles configured therewithin (e.g., on average). In more specific embodiments, the graphene pocket(s) comprise 1-50 (e.g., 1-5, or 2-5) active electrode material containing (e.g., silicon-containing) particles configured therewithin (e.g., on average). In some embodiments, pockets described herein have a volume that is greater than the volume of the particle(s) configured therewithin. In certain instances, pocket volume excess is desirable, particularly when the active electrode material expands during lithiation, such as Si and/or SiOx. In some instances, during expansion, the excess volume allows the particles to expand while reducing the opportunity for the web coating to become displace and/or while reducing the overall volume expansion of the electrode material. In certain embodiments, the void space within the pocket is at least 3% greater (e.g., at least 5% greater, at least 10% greater, at least 20% greater, or the like) than the volume of the active electrode containing particle(s) configured therewithin.

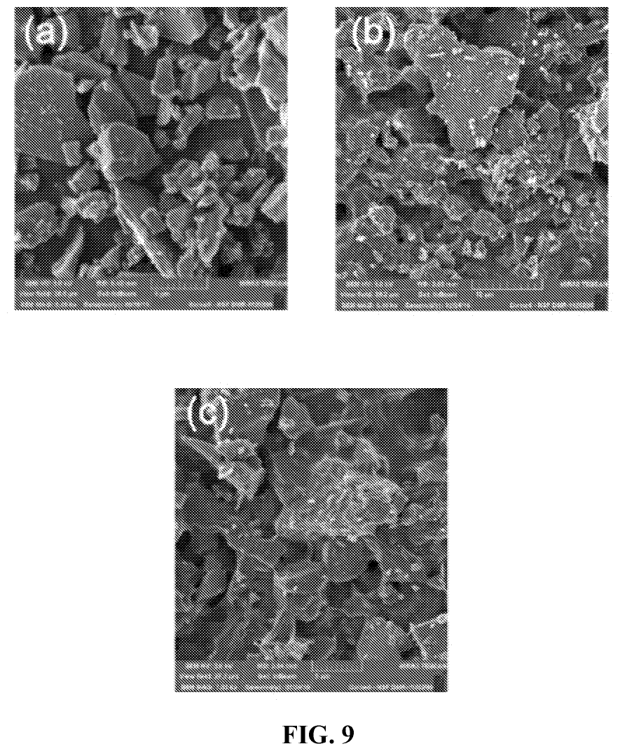

In certain embodiments, a composition (e.g., pre- and/or post-thermally treated composition) provided herein comprises active electrode material containing particles secured within a carbonaceous web (e.g., graphenic web). In some embodiments, the web defines one or more pockets (e.g., graphenic pockets) within which one or more of the active electrode material containing particles are configured. In some embodiments, a graphenic web is a collection of a plurality of graphenic component sheets (e.g., graphene sheets, graphene oxide sheets, reduced graphene oxide sheets, or combinations thereof) that collectively form a layer having a surface area larger than the surface area of a single sheet. In some instances, the graphenic components overlap, adjoin, abut, or otherwise interact or interface with one another (e.g., through non-covalent forces). In certain embodiments, the carbonaceous (e.g., graphenic) film comprises a continuous web defining a large number of carbonaceous pockets therein. In some embodiments, the continuous web extends throughout the composition, providing a continuous, self-supporting film. In other embodiments, a carbonaceous web forms a coating or wrap around one or more active electrode material containing particles in a single graphenic pocket, such as without having interconnectivity with a second graphenic pocket structure. FIG. 5 and FIG. 9 illustrates graphenic webs having a high degree of interconnectivity between graphenic pockets.

As illustrated in the figures (e.g., FIG. 5, FIG. 9) provided herein good coverage of active electrode materials are provided with a graphenic web. In some embodiments, a film or composition provided herein has an externally exposed surface (e.g., including the top surface and other exposed surfaces of the materials exemplified in the figures herein), the externally exposed surface being comprised primarily of carbonaceous material. In specific instances, the electrode active material (e.g., SiOx) has very little external exposure in the film or composition, even more limited than in cases where a top coat is not present, such as described herein. In some instances, this is important to maximizing electrode performance characteristics, such as by minimizing pulverization and/or SEI formation. In some embodiments, less than 5% of the surface of a film provided herein is active electrode material or SiOx by surface area. In preferred embodiments, compositions, films, or (coated) particles provided herein comprise less than 3% electrode active material or SiOx by surface area. In more preferred embodiments, compositions, films, or (coated) particles provided herein comprise less than 1% electrode active material or SiOx by surface area. In some embodiments, compositions, films, or (coated) particles provided herein is at least 90% graphenic (e.g., characterized by a graphene component described herein) by surface area. In preferred embodiments, compositions, films, or (coated) particles provided herein is at least 95% graphenic by surface area. In more preferred embodiments, compositions, films, or (coated) particles provided herein is at least 98% (e.g., at least 99%) graphenic by surface area.

Provided in specific embodiments herein is a (e.g., base) composition or film (e.g., comprising a base and top coat) comprising a plurality of active electrode material (e.g., silicon) containing particles and a plurality of carbon inclusions (e.g., graphene components, oxidized graphene components, oxidized graphene components that have been reduced, or the like). In specific embodiments, the carbon inclusions are oxidized graphene components. In other specific embodiments, the graphene components are oxidized graphene components that have been reduced. In some embodiments, the compositions comprise a plurality of silicon-carbon composite domains. In specific embodiments, silicon-carbon composite domains comprise an (e.g., graphenic) envelope, the envelope comprising an external surface and an internal surface, the internal surface defining an envelope pocket. In some embodiments, one or more of the plurality of active electrode material (e.g., silicon) containing particles are configured within the envelope pocket. In some embodiments, the envelope comprises one or more of the plurality of carbon inclusions (e.g., graphene components, oxidized graphene components, or the like). In some embodiments, provided herein is composition comprising graphene oxide and a plurality of silicon-containing particles, the graphene oxide configured to form a plurality of graphene oxide envelopes, the plurality of silicon-containing particles being configured within the plurality of graphene oxide envelopes. In some embodiments, provided herein is composition comprising reduced graphene oxide and a plurality of silicon-containing particles, the reduced graphene oxide configured to form a plurality of reduced graphene oxide envelopes, the plurality of silicon-containing particles being configured within the plurality of reduced graphene oxide envelopes. Also provided herein are such envelopes (e.g., graphene envelopes) comprising a plurality of particles (e.g., comprising electrode active material, such as silicon) therein.

In some embodiments, a (e.g., micro- or nano-structured) silicon material is dispersed in and/or on a carbon (e.g., graphene) matrix, web (e.g., wherein the graphene matrix or web comprises a graphene structure or analog as described herein), pockets, and/or envelopes. In certain embodiments, the carbon web (e.g., comprising envelopes thereof) is about 25 wt. % or more (e.g., about 50 wt % or more, about 60 wt % or more, about 75 wt % or more, about 85 wt % or more, about 90 wt % or more, or about 95 wt % or more) graphene component. In certain embodiments, the silicon material comprises a plurality of nanostructures (e.g., such nanostructures comprising a nanoscale (e.g., having an average dimension of less than 2 micron, or less than 1 micron) structure in any one or more dimension, such as nanostructured fibers, particles, sheets, rods, and/or the like) comprising a silicon material. In some embodiments, the silicon material comprises a plurality of larger structures, such as microstructures (e.g., having an average dimension of less than 100 micron, less than 50 micron, or less than 30 micron, preferably less than 25 micron, less than 20 micron, less than 15 micron, less than 10 micron, or the like, such as down to about 200 nm). Other details of the suitable electrode active materials and/or silicon-containing or based materials, inclusions, or structures are as described herein. Further, in some instances, such as wherein larger structures are utilized, larger droplets or particles are necessarily formed upon electrospray according to the processes described herein.

In certain embodiments, silicon materials included herein include a silicon material that is active in an electrode, such as a negative electrode in a lithium ion battery, such as elemental silicon, and/or a silicon oxide (e.g., having a formula: SiOx, wherein 0≤x<2, e.g., 0≤x≤1.5, 0<x<1, or x≈0). In specific embodiments, silicon materials and/or inclusions included in the compositions, materials, and electrodes described herein comprise silicon (elemental silicon), such as crystalline silicon. In some embodiments, silicon-containing particles provided herein comprise 40 wt. % or more electrode active silicon material (e.g., SiOx, e.g., wherein 0≤x<2). In specific embodiments, silicon-containing particles provided herein comprise 50 wt. % (e.g., 60 wt % or more, 70 wt. % or more, 80 wt % or more, or the like) or more electrode active silicon material (e.g., SiOx). In some embodiments, silicon-containing particles provided herein comprise 40 wt. % or more electrode active silicon (Si). In specific embodiments, silicon-containing particles provided herein comprise 50 wt. % (e.g., 60 wt % or more, 70 wt. % or more, about 70 wt. % to about 80 wt %, 80 wt % or more, or the like) or more silicon (Si). In certain embodiments, higher amounts of silicon (Si) and lesser amounts of SiOx (wherein 0<x≤2) is desired, such as to minimize impedence of lithiation.

Provided in certain embodiments herein are compositions (or materials) comprising a plurality of active electrode inclusions (e.g., silicon-containing particles) and a plurality of carbon inclusions (e.g., graphene components, such as a reduced graphene oxide component, such as rGO). In certain embodiments, the carbon inclusions (e.g., graphene components) collective form a web, a plurality of carbon envelopes (e.g., graphene envelopes), or a web comprising a plurality of carbon envelopes. In certain embodiments, each envelope comprises one or more (e.g., at least 2) carbon inclusions (e.g., graphene components, such as a reduced graphene oxide component, such as rGO). In general, each envelope comprises an internal surface and an external surface, the internal surface defining an envelope pocket. In some instances, individual carbon inclusions optionally form all or part of one or more envelope, such as illustrated in FIG. 4. In certain instances, the external surface of one envelope forms all or part of the internal surface of a second envelope. In various embodiments, the web and/or envelopes taken together with active electrode materials comprise a plurality of composite domains within the composition or material. In specific embodiments, composite domains comprise an envelope and active material (e.g., inclusions, such as particles thereof).

In specific embodiments provided herein is a composition or material comprising a graphene component, such as an oxidized graphene component (e.g., graphene oxide). In certain embodiments, a composition or material herein comprises a plurality of graphene envelopes, the graphene envelopes comprising one or more oxidized graphene components (e.g., graphene oxide). In some embodiments, such compositions or materials are precursor materials to electrode materials described herein. In certain embodiments, such precursor materials are converted to electrode materials via reductive reaction conditions, such as through thermal, chemical, or other processes described herein. In specific embodiments, the oxidized graphene component is a graphene component functionalized with oxygen, such as with carbonyl groups, carboxyl groups (e.g., carboxylic acid groups, carboxylate groups, COOR groups, such as wherein R is a C1-C6 alkyl, or the like), —OH groups, epoxide groups, and/or the like. In certain embodiments, the oxidized graphene component (or graphene oxide) comprises about 60% or more carbon (e.g., 60% to 99%). In more specific embodiments, the oxidized graphene component comprises about 60 wt. % to about 90 wt. % carbon, or about 60 wt. % to about 80 wt. % carbon. In further or alternative specific embodiments, the oxidized graphene component comprises about 40 wt. % oxygen or less, such as about 10 wt. % oxygen to about 40 wt. % oxygen, about 35 wt. % oxygen or less, about 1 wt. % to 35 wt. % oxygen, or the like.

In some embodiments, the weight ratio of active electrode material or silicon-containing particles to carbon inclusion of compositions, films, or materials (e.g., precursor materials, such as comprising graphene oxide) is about 1:10 to about 20:1. In certain embodiments, the weight ratio of active electrode material or silicon-containing particles to carbon inclusion of about 1:4 to about 10:1, such as about 1:2 to about 5:1, or about 1:1 to about 3:1. Other ratios, such as those described herein are also contemplated. In various instances, such ratios include ratios of the active electrode material containing domain, composition or coat, or of the entire film (e.g., both base and top coats).

In other specific embodiments provided herein is a composition or material comprising a graphene component, such as an oxidized graphene component that has been reduced (e.g., reduced graphene oxide). In certain embodiments, a composition or material herein comprises a plurality of graphene envelopes, the graphene envelopes comprising one or more (oxidized or reduced oxidized) graphene components (e.g., reduced graphene oxide). In some embodiments, such compositions or materials are electrode materials prepared from precursor materials described herein. In certain embodiments, such electrode materials are converted from precursor materials via reductive reaction conditions, such as through thermal, chemical, or other processes described herein. In specific embodiments, the (e.g., reduced oxidized) graphene component is a graphene component functionalized with oxygen, such as with carbonyl groups, carboxyl groups (e.g., carboxylic acid groups, carboxylate groups, COOR groups, such as wherein R is a C1-C6 alkyl, or the like), —OH groups, epoxide groups, and/or the like. While oxidized graphene components generally comprise less oxidation that oxidized graphene components, residual oxidation and defects remain present in some instances. In certain embodiments, the graphene component (e.g., reduced graphene oxide) comprises about 60% or more carbon (e.g., 60% to 99%), such as about 70 wt. % or greater, about 75 wt. % or more, about 80 wt. % or greater, about 85 wt. % or greater, about 90 wt. % or greater, or about 95 wt. % or greater (e.g., up to about 99 wt. % or more). In certain embodiments, the graphene component (e.g., rGO) comprises about 35 wt. % or less (e.g., 0.1 wt. % to 35 wt. %) oxygen, e.g., about 25 wt. % or less (e.g., 0.1 wt. % to 25 wt. %) oxygen, or about, about 20 wt. % or less, about 15 wt. % or less, about 10 wt. % or less (e.g., down to about 0.01 wt. %, down to about 0.1 wt. %, down to about 1 wt. % or the like) oxygen. In specific embodiments, the graphene component (e.g., rGO) comprises about 0.1 wt. % to about 10 wt. % oxygen, e.g., about 4 wt. % to about 9 wt. %, about 5 wt, % to about 8 wt, %, or the like.

In certain embodiments, e.g., wherein a carbon inclusion material (e.g., graphene component) is reduced, higher ratios of active electrode material or silicon-containing particles to carbon inclusion are contemplated for compositions, materials, and electrodes described herein. In some embodiments, the weight ratio of active electrode material or silicon-containing particles to carbon inclusion of compositions or materials (e.g., electrode materials, such as comprising reduced graphene oxide) is about 1:5 to about 20:1. In certain embodiments, the weight ratio of active electrode material or silicon-containing particles to carbon inclusion of about 1:2 to about 20:1, such as about 1:1 to about 10:1, or about 2:1 to about 9:1.

In certain embodiments, envelopes of compositions, materials, and electrodes described herein comprise any suitable number of active material inclusions (or precursors thereof) in the pockets thereof. In some embodiments, individual envelopes comprise one or more inclusions therein. In specific embodiments, individual envelopes comprise 2 or more (e.g., 2-10, 2-5, or the like) inclusions therein. In certain instances, such as wherein larger inclusions (e.g., micro-structured inclusions, such as having a particle size (or average dimension) of greater than about 200 nm on average, about 1 micron to about 10 micron, or the like are utilized, fewer inclusions are found within the envelope pockets, such as about 1 to about 10, or about 2 to about 5 inclusions on average, or 1 to 10, e.g., 2 to 5, in individual envelopes. In some instances, such as wherein smaller inclusions (e.g., nano-structured inclusions, such as having one or more, or an average dimension, of less than 200 nm, more inclusions may be found within the envelope pockets, such as about 1 to about 1000 on average (e.g., about 50 to about 200, such as about 100), or 1 to 1000 (e.g., 50 to 20, such as about 100) in individual envelopes.

Also provided in some embodiments herein are articles of manufacture comprising a silicon/carbon deposition described herein, e.g., a thin-layered deposition, manufactured or capable of being manufactured according to the processes described herein. In certain embodiments, provided herein is a substrate, such as a conductive substrate (e.g., current collector), comprising an electrode or deposition described herein on the surface thereof. In addition, provided herein are devices, such as energy storage devices, including, e.g., batteries, such as lithium ion batteries, comprising such materials described herein.

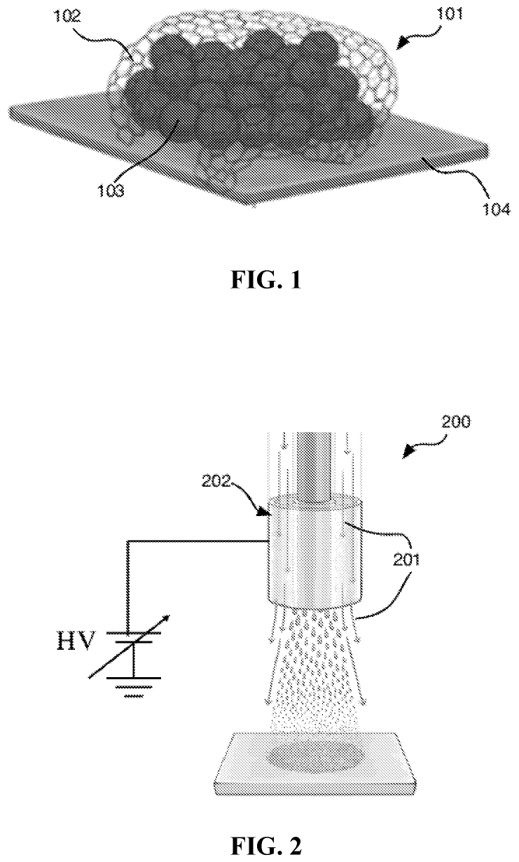

In certain embodiments, provided herein is an electrode (or, e.g., a lithium ion battery comprising such an electrode) comprising a carbon web securing a plurality of nanostructured inclusions, the nanostructured inclusions comprising an electrode active material (e.g., a negative electrode active material, such as a silicon material described herein). FIG. 1 illustrates an electrode deposition 101 on a current collector 104. As illustrated, the electrode may comprise carbon web 102 securing a plurality of electrode active nanostructures 103. As illustrated in FIG. 1, in some instances, the carbon material 102, such as carbon sheets or ribbons (e.g., graphene, graphene oxide (GO), reduced graphene oxide (rGO), or other graphene analogs), wrap and secure the electrode active nanostructures 103. In some instances, the carbon material 102 securing the electrode active material 103 functions to protect the electrode active material 103 from interactions with electrolyte, from pulverization, and/or the like. In addition, in some instances, such as wherein low electron conductivity electrode active materials are utilized, the carbon material 102 facilitates electron conductivity in the electrode.

In some embodiments, the active electrode material is included in the form of or as a part of a particulate inclusion (e.g., nanoscaled—such as less than about 2 micron in at least one dimension—particulate (e.g., nanoparticles being less than about 2 micron in all dimensions, and nanorods and nanofibers being less than about 2 micron in diameter and greater or less than about 2 micron in a second dimension); or other small structured particle, such as having an average dimension as described herein, such as less than 30 micron, less than 20 micron, less than 15 micron, or the like (e.g., particles, rods or other structure configuration). In specific embodiments, nano-inclusions (e.g., nanoparticles) have nanoscale morphologies that are about 1 micron or less, about 500 nm or less, about 250 nm or less, or about 100 nm or less. In more specific embodiments, at least one dimension (e.g., all dimensions for a nanoparticle) is about 50 nm or less, or about 25 nm or less or about 10 nm or less, or about 5 nm to about 10 nm, or any other suitable size. In some specific embodiments, the particulate inclusion is in the form of a high aspect ratio structures, such as a nanorod or nanofiber. In specific embodiments, the high aspect structures have a first dimension that is about 2 microns or less, such as about 1 micron or less, about 0.5 micron or less, or about 0.1 micron to about 0.2 micron. In specific embodiments, such high aspect ratio structures have an aspect ratio of about 10 or more, about 20 or more, about 25 or more, or about 50 or more, such as up to about 250. In certain embodiments, the second dimension of the high aspect ratio structures is about 50 micron or less, such as about 1 micron to about 50 micron, about 2 micron to about 25 micron, or the like. FIG. 9 illustrates particles comprising active material (e.g., SiOx) in (a) pristine form, as well as (b) and (c) covered by carbon (e.g., graphene oxide) (at various zoom levels). As can be seen in the image, very good coverage of the particles with the carbon is achieved. Further, as can be seen in FIG. 9, the use of graphene components that have an average dimension (length and/or width) of greater than the average or smallest dimension (e.g., diameter or length, width, height) of the particle provides good coverage for multiple particles (e.g., provides a carbon envelope enclosing multiple particles).

In certain instances, high Coulombic efficiency (η_{c}) values, particularly on first cycle Coulombic efficiencies, are important to commercial battery applications (η_{c}=Qₒᵤₜ/Qᵢₙ, wherein Qₒᵤₜ is the amount of charge that exits the battery during the discharge cycle, and Qᵢₙ is the amount of charge that enters the battery during the charging cycle). In some instances, poor first cycle Coulombic efficiencies of an anode results in a capacity loss and/or capacity mismatch between anode and cathode. For example, if an anode irreversibly loses more than 15% of its capacity during the first cycle, there can be a large capacity mismatch between the anode and cathode. In some instances, excess electrode material is optionally utilized to make up for a mismatch, but typical commercial battery applications require a first cycle Coulombic efficiency of about 85% or more for a lithium ion battery anode material. In certain embodiments, electrodes and/or electrode materials (e.g., films) provided herein have a first cycle Coulombic efficiency of about 80% or more, more preferably about 85% or more. In more preferred embodiments, the electrodes and/or electrode materials (e.g., films) provided herein have a first cycle Coulombic efficiency of about 88% or more, more preferably about 90% or more.

In certain embodiments, provided herein is a thin layer electrode (e.g., comprising an electrode material provided herein) deposited on a current collector (e.g., in two parts). In some embodiments, the electrode is well adhered to the current collector. In specific embodiments, the electrode is adheres to the current collector such that after at least two times (e.g., at least three times, at least five times, or the like) folding the electrode/current collector at an angle of at least 90 degrees (e.g., at least 135 degrees), there is less than 10% (e.g., less than 5%, less than 3%, less than 1%, or the like) exfoliation of the electrode (e.g., wherein the exfoliation is the % separation of the electrode from the current collector, e.g., by area).

In certain embodiments, the electrode is a thin layer electrode (e.g., deposited on a current collector). In specific embodiments, the electrode has a thickness of about 500 microns or less, e.g., about 250 microns or less, about 200 microns or less, about 25 microns to about 500 microns, about 50 microns to about 200 microns, or the like. In some embodiments, the electrode has a mass loading on a substrate of about 10 mg/cm² or less, such as about 0.1 mg/cm² to about 10 mg/cm², about 5 mg/cm² or less, about 4 mg/cm² or less, about 3 mg/cm² or less, about 1 mg/cm² to about 2 mg/cm². In certain embodiments, despite thin films being utilized, high areal density materials are utilized, such as about 0.1 mg/cm² or more, about 0.5 mg/cm² or more, or about mg/cm² or more (such as about 0.5 mg/cm² to about 5 mg/cm², e.g., about 1 mg/cm² to about 5 mg/cm²). In certain embodiments, electrodes and/or materials provided herein have good capacity by area of electrode. For example, in some embodiments, electrodes and materials provided herein have an areal capacity of at least 1 mAh/cm², such as about 2 mAh/cm² or more, about 3 mAh/cm² or more, or about 2 mAh/cm² to about 5 mAh/cm². FIG. 12 illustrates capacities and capacity retention of exemplary full cells having an anode with a capacity of about 3 mAh/cm², up to about 2 times greater than exhibited in conventional lithium ion battery full cells.

In various embodiments, the current collector is any suitable material, such as a metal (e.g., aluminum, copper, or the like) (such as a metal foil) or a carbon substrate (e.g., carbon cloth, carbon paper, or the like). In certain embodiments, a carbon substrate provides improved flexibility to the combined electrode and current collector product.

In various embodiments, electrode materials and electrodes provided herein have high capacities (e.g., specific capacities in a lithium ion cell, such as a half cell or full cell). In some embodiments, the electrode or electrode material has a specific capacity (e.g, in a half cell) of at least 1,500 mAh/g, at least 1,750 mAh/g, at least 2,000 mAh/g, at least 2,200 mAh/G, or the like at a charge rate of at least C/3 (e.g., C/2) (e.g., wherein C is the rate required to charge/discharge a battery in 1 hour). In specific embodiments, the electrode material and/or electrode has a specific capacity of about 500 mAh/g or more at a charge rate of about 1 A/g. In more specific embodiments, the electrode material and/or electrode has a specific capacity of about 600 mAh/g or more at a charge rate of about 1 A/g. In still more specific embodiments, the electrode material and/or electrode has a specific capacity of about 700 mAh/g or more at a charge rate of about 1 A/g. In yet more specific embodiments, the electrode material and/or electrode has a specific capacity of about 800 mAh/g or more at a charge rate of about 1 A/g. In more specific embodiments, the electrode material and/or electrode has a specific capacity of about 1000 mAh/g or more (e.g., about 1100 mAh/g or more, or about 1200 mAh/g or more) at a charge rate of about 1 A/g. In some embodiments, the electrode material and/or electrode has a specific capacity of about 500 mAh/g or more at a charge rate of about 2 A/g. In more specific embodiments, the electrode material and/or electrode has a specific capacity of about 600 mAh/g or more at a charge rate of about 2 A/g. In still more specific embodiments, the electrode material and/or electrode has a specific capacity of about 700 mAh/g or more at a charge rate of about 2 A/g. In yet more specific embodiments, the electrode material and/or electrode has a specific capacity of about 800 mAh/g or more at a charge rate of about 2 A/g. In more specific embodiments, the electrode material and/or electrode has a specific capacity of about 1000 mAh/g or more (e.g., about 1100 mAh/g or more, or about 1200 mAh/g or more) at a charge rate of about 2 A/g. In certain embodiments, such capacities are observed on the initial cycle (charge and/or discharge cycle), on or after the 2^{nd} cycle, on or after the 5^{th} cycle, on or after the 10^{th} cycle, on or after the 50^{th} cycle, on or after the 100^{th} cycle, on or after the 150^{th} cycle, on or after the 200^{th} cycle, on or after the 250^{th} cycle, or a combination thereof. In certain embodiments, the specific capacity of the electrode material and/or electrode on or after the 200^{th} and/or 250^{th} cycle (e.g., charge and/or discharge cycle) is about 80% or more (e.g., 85% or more) of the specific capacity of the electrode material and/or electrode on the 1^{st} cycle, the 5^{th} cycle, and/or the 10^{th} cycle.

In some embodiments, provided herein is a battery (e.g., a lithium battery, such as a lithium ion battery) comprising an electrode or electrode material described herein. In specific embodiments, a battery provided herein comprises a positive electrode and a negative electrode, at least one electrode thereof being an electrode described herein In some embodiments, provided herein is a battery comprising a negative electrode comprising a direct deposit electrode described herein, an electrode material described herein, and/or a carbon-silicon web and/or envelope described herein. In more specific embodiments, provided herein is a lithium ion battery comprising a negative electrode, a positive electrode, a separator, and an electrolyte, the negative electrode comprising an electrode described herein (e.g., a carbon web securing a plurality of nanostructured inclusions therein, the nanostructured inclusions comprising an active (electrode) material).

In some embodiments, provided herein are binder-free electrodes, such as made possible by the manufacturing processes described herein. Provided in some embodiments herein is a general method of manufacturing such electrodes using any suitable materials. In some instances, provided herein is a general approach to manufacturing very uniform electrodes, in a very efficient manner. In specific instances, processes described herein provide for the direct deposition of electrode on a conductive substrate (e.g., current collector) without the need for downstream processing, such as drop casting, slurry casting, undergoing long or high temperature drying steps, and/or the like.

In certain embodiments, a film provided herein has a first domain and a second domain, such as a base coat and a top coat. In some embodiments, the first domain or base coat comprises an active electrode material inclusion and a carbon inclusion, such as described herein and in the morphologies described herein (e.g., wherein the active electrode material (e.g., silicon containing) inclusions reside within graphenic pockets, etc.). In specific embodiments, the active electrode material inclusions are SiOx inclusions and the carbon inclusions are graphenic components. In more specific embodiments, the graphenic component is graphene oxide (e.g., wherein the film is an anode or anode material precursor), or reduced graphene oxide (e.g., wherein the film is an anode or anode material). In certain embodiments, the top coat is free or substantially free from non-graphitic, non-graphenic, high capacity, and/or silicon-containing active electrode materials. For example, in some instances, the top coat comprises less than 10 wt. % high capacity or silicon-containing active electrode materials or inclusion particles. In more specific embodiments, the top coat comprises less than 5 wt. %, less than 3 wt. %, less than 2 wt. %, or less than 1 wt. % high capacity or silicon-containing active electrode materials or inclusion particles. In some instances, the top coat is a continuous structure, or a non-continuous film. In certain instances, the top coat is so thin that the coverage is insufficient to form a continuous film.

In some embodiments, a base (active electrode or silicon containing) coat has a base coat average thickness, and the top coat has a top coat average thickness, with the ratio of the base coat average thickness to the top coat average thickness being at least 1:1. In preferred embodiments, the ratio of the base average thickness to the top coat average thickness is at least 2:1. In more specific embodiments, the ratio of the base coat average thickness to the top coat average thickness is at least 5:1 (e.g., at least 10:1). In some embodiments, the first composition is highly loaded on the substrate, such as having a loading by area (“areal loading”) of at least 0.3 mg/cm². In more specific embodiments, the loading of the first composition or domain is at least 0.5 mg/cm², such as at least 1 mg/cm². In some embodiments, the loading of the top coat is low (e.g., relative to the base coat), such as having an areal loading of less than 0.3 mg/cm². In specific embodiments, the second composition or domain has an areal loading of about 0.001 mg/cm² to about 0.3 mg/cm², such as about 0.001 mg/cm² to about 0.2 mg/cm², about 0.001 mg/cm² to about 0.1 mg/cm², about 0.005 mg/cm² to about 0.2 mg/cm², or about 0.01 mg/cm² to about 0.1 mg/cm².

In certain embodiments, a film provided herein (e.g., pre- or post-reductive or thermal treatment) is a thin film, such as having an overall thickness (e.g., incorporating both the top coat and base coat, but not the substrate) of about 100 micron or less (e.g., about 50 micron or less, about 5 micron to about 25 micron, about 10 micron to 20 micron, or the like). In specific embodiments, the film has an average thickness of about 5 micron to about 35 micron. In some embodiments, the base coat has an average thickness of less than 25 micron (e.g., about 3 micron to about 25 micron, about 3 micron to about 20 micron, or about 5 micron to about 15 micron). In certain embodiments, the second domain has an average thickness of about 0.1 micron to about 10 micron. In certain embodiments, the overall film, the base coat, the top coat, or any combination thereof has a thickness variation of less than 50%, e.g., less than 30%, less than 20%, less than 10%, or the like. Any suitable bulk density is contemplated for overall films, top coats, and base coats, such as about 0.3 grams per cubic cm or more, such as about 0.5 grams per cubic cm or more.

In some embodiments, a film provided herein has an externally exposed surface, the externally exposed surface comprising at least 90% (e.g., at least 95%, at least 97%, at least 98%, at least 99%, or the like) carbon inclusion (e.g., second and/or first carbon inclusion/component) by surface area. In certain embodiments, less than 5% (e.g., less than 3%, less than 2%, less than 1%, or the like) of the surface of the film is comprised of the active electrode material.

In certain embodiments, the carbonaceous components constitute at least 70 wt. % of the overall film surface. In more specific embodiments, the carbonaceous components constitute at least 80 wt. % of the film surface. In still more specific embodiments, the carbonaceous components constitute at least 90 wt. % (e.g., at least 95 wt. %) of the film surface. In some embodiments, the active electrode material or active electrode material-containing inclusions constitute about 50 wt. % to about 95 wt. % of the film. In certain embodiments, the carbonaceous components constitute about 5 wt. % to about 50 wt. % of the film.

In various embodiments herein, inclusions and materials are described as having specific characteristics. It is to be understood that such disclosures include disclosures of a plurality of such inclusions having an average equal to the specific characteristics identified, and vice-versa.

In various embodiments, “electrodes” referred to herein as comprising certain characteristics, functionality, and/or component parts includes a disclosure of electrode materials with the same characteristics, functionality, and/or component parts. In addition, reference to a solution herein, includes liquid compositions wherein inclusion parts are dissolved and/or dispersed therein.

### EXAMPLES

### Example 1

Various electrodes and electrode materials are prepared using active materials (silicon or a (substoichiometric) silicon oxide) particles. 3.0 g of GO aqueous suspension is diluted in 5.0 g of DI water. After sonicating the suspension for 1 hr, 60 mg or 120 mg active materials (1:1 or 2:1 weight ratio with graphene oxide) are added. The mixture of active material and graphene oxide are then sonicated for another hour and stirred overnight before spraying. Air-controlled electrospray is applied for manufacture of electrode materials, including directly depositing binder-free electrodes. The electrospray is carried out under ambient condition using a Harvard Apparatus PHD 2000 Infusion syringe pump with a coaxial needle set. Solution is supplied through the inner 17 G needle and gas through outer 12 G needle. The working voltage is set at 20 kV, working distance at 20 cm, solution feeding rate between 0.05 mL min⁻¹-0.1 mL min⁻¹, and gas pressure at 28 psi. To obtain active materials/RGO electrodes, the as sprayed active materials/GO are annealed at 400° C. in N₂ atmosphere (tube furnace) for 1 hr to reduce GO, ramp 5° C./min. Direct deposit electrodes are deposited on copper foil.

The structure and morphology of the samples are characterized by scanning electron microscopy (SEM, LEO 1550) and transmission electron microscopy (TEM, FEI T12 Spirit). The active material and carbon ratio is determined by thermogravimetric analysis (TA instruments Q500). Electrochemical measurement is conducted using CR-2032 coin cell. The electrodes prepared above are directly used without any further treatment. 1 M LiPF6 in a mixture of ethylene carbonate, diethyl carbonate and dimethyl carbonate (2:1:2 by vol %) with an additive of 10 wt % fluoroethylene carbonate is used as electrodes for silicon related materials. In half cell, a lithium foil is used as counter electrode. LiCoO₂ electrode (MTI.) was used as cathode in full cells. Cell assembly is carried out in an argon-filled glove-box. The galvanostatic charge/discharge measurements are performed using a Land battery testing system in the voltage cutoff window of 0.01-1.5V for half cells, and 2.5-4.2V for full cells. The current density and specific capacity are based on the total mass of electrode materials. Cyclic voltammetry is measured using a PARSTAT 4000 (Princeton Applied Research) electrochemical work station. In some instances, the cells are stabilized with a 3-10 pre-cycles (i.e., cycles prior to initial cycles; 1^{st} cycle coulombic efficiencies refer, however, to the absolute first cycle, whether it is a pre-cycle or otherwise). Unless otherwise noted, cycling rates are typically 1 C.

### Example 2

Using a process as described in Example 1, direct deposited anodes are prepared using active material particles in an initial in an initial particles:GO weight ratio of 4:3. Samples are prepared using both fully exfoliated, single-layer and multi-layered graphene oxide (GO).

Half cells are identically prepared using the single layer graphene oxide and three samples of multi-layered graphene oxide samples. FIG. 6 illustrates the capacities of the samples prepared using single layered (filled circles) and multi-layered graphene oxide (3×; triangles and open circles). The single layered graphene samples begin with the highest initial capacity of about 2500 mAh/g, with the multi-layered graphene samples having an initial capacity of about 2400 mAh/g. After several cycles, however, the multi-layered graphene samples exhibited capacities that were equivalent with or better than that of the single-layered graphene samples. These results indicate a much better capacity retention for the multi-layered graphene samples. FIG. 10 demonstrates the capacity retention values of the various samples, with the multi-layered graphene samples (triangles and open circles, corresponding to multiple iterations of the multi-layered graphene samples) demonstrating a capacity retention that is up to 10% greater or more over 100 cycles than the single layered graphene samples (filled circles). As illustrated in FIG. 10, the multi-layered graphene samples consistently demonstrate significant improvement over the single layered graphene samples.

Similar cells are also prepared to compare the 1^{st} cycle Coulombic efficiency for single layered graphene samples versus multi-layered graphene samples. Good 1^{st} cycle Coulombic efficiencies are obtained for all samples, with 1^{st} cycle Coulombic efficiencies of about 87-88% achieved for single layered graphene samples. Greater 1^{st} cycle Coulombic efficiencies were obtained for the multi-layered graphene samples, however, with values of about 88-91% achieved.

### Example 3

Using a process similar to that described in Examples 1, cells using anodes prepared with natural flake graphite derived graphene oxide are prepared and compared to a the single-layered graphene samples described in Example 2. As is discussed in Example 2, cells using anodes with multi-layered graphene again demonstrated superiority over the single-layered graphene samples, even when sourcing the graphene oxide raw material from natural flake graphite, rather than synthetic sources (as used in the single and multi-layered graphene oxide samples of Example 2).

As illustrated in FIG. 11 and FIG. 12, better initial capacities (about 2500 mAh/g or more) are demonstrated for the natural flake graphite derived multi-layered graphene than for the synthetic graphite derived graphene of Example 2. Similarly, capacity retention values for the natural flake graphite derived multi-layered graphene (triangles and open circles) samples demonstrate consistent and clear separation from the synthetic graphite derived single layered graphene samples (filled circles) after only a few cycles.

What is claimed is:

1. A process for manufacturing an electrode material, the process comprising:
a. producing an plume or aerosol from a fluid stock (e.g., from a plume or aerosol producing nozzle), the fluid stock comprising a plurality of inclusion particles and a liquid medium, the inclusion particles comprising a plurality of active electrode material-containing particles, and a plurality of multi-layered graphenic (e.g., graphene oxide) inclusions (e.g., the plurality of carbon inclusions comprising a plurality of first graphene components comprising at least 50 wt % carbon and about 10 wt % to about 50 wt % oxygen), and
b. collecting a first composition on a substrate, the first composition being a first film comprising the plurality of active electrode material-containing particles secured within one or more first graphenic web, the one or more first graphenic web comprising the plurality of multi-layered graphenic components.

2. The process of claim 1, wherein the electrode is a lithium ion battery anode.

3. The process of claim 2, wherein the electrode material is a silicon-carbon electrode material.

4. The process of any one of the preceding claims, wherein the active electrode material-containing electrode is a silicon-containing material.

5. The process of claim 4, wherein the silicon-containing material is SiOx, wherein 0≤x<2.

6. The process of claim 5, wherein 0≤x<0.5.

7. The process of any one of the preceding claims, wherein the plume or aerosol is generated by electrospraying the fluid stock.

8. The process of any one of the preceding claims, wherein the plume or aerosol is generated in the presence of a high velocity gas.

9. The process of claim 8, wherein the high velocity gas has a velocity of at least 0.5 m/s.

10. The process of any one of the preceding claims, wherein the plume or aerosol is generated by providing the fluid stock to a first inlet of a first conduit of an electrospray nozzle, the first conduit being enclosed along the length of the conduit by a first wall having an interior surface and an exterior surface, the first conduit having a first outlet, and providing a voltage to the electrospray nozzle.

11. The process of claim 10, further comprising providing a pressurized gas to a second inlet of a second conduit of the nozzle, the second conduit having a second inlet and a second outlet, and at least a portion of the second conduit being positioned in surrounding relation to the first conduit.

12. The process of claim 11, wherein the second conduit is enclosed by a second wall, the second wall having an interior surface.

13. The process of any one of the preceding claims, wherein the multi-layered graphenic component comprises at least 2 graphenic layers (e.g., at least 3 layers, at least 5 layers, 5-50 layers, or 5-25 layers).

14. The process of either one of claim 12 or 13, wherein the gas has a velocity of at least 0.5 m/s at the second outlet.

15. The process of any one of the preceding claims, wherein the process comprises collecting the first composition on a substrate, the substrate having a substrate surface in opposing relation to the electrospray nozzle.

16. The process of any one of the preceding claims, wherein the plume or aerosol comprises a plurality of plume particles, and the plurality of plume particles within d/4 of the substrate comprise about 50 total inclusion particles or fewer, wherein d is the average distance between the nozzle (e.g., first outlet of the nozzle) and the substrate surface.

17. The process of any one of the preceding claims, wherein the substrate is affixed to or a part of a conveyor system.

18. The process of any one of the preceding claims, further comprising thermally treating the first composition to provide a second composition.

19. The process of claim 18, wherein the second composition comprising a plurality of thermally treated silicon-containing particles secured within one or more second graphenic web, the one or more second graphenic web comprising the plurality of second multi-layered graphenic components.

20. The process of claim 19, wherein the plurality of second multi-layered graphenic components comprising about 85 wt. % or more carbon and about 0.1 wt. % to about 15 wt. % oxygen.

21. The process of any one of claims 18-20, wherein the second composition comprises about 50 wt. % to about 95 wt. % SiOx.

22. The process of any one of claims 19-21, wherein the second graphenic component constitutes about 5 wt. % to about 50 wt. % of the second composition.

23. The process of any one of the preceding claims, further comprising compressing the first and/or second composition(s).

24. The process of any one of the preceding claims, wherein the first and/or second composition has a thickness of about 1 mm or less (e.g., about 250 micro or less, about 100 micron or less, about 50 micron or less, about 20 micron or less, or the like).

25. The process of any one of the preceding claims, wherein the first and/or second composition has a bulk density of about 0.5 grams per cubic cm or more (e.g., about 1 gram per cubic cm or more, about 1.5 gram per cubic cm or more, or the like).

26. The process of any one of the preceding claims, wherein the active electrode material-containing particles and the plurality of first graphene components constitute at least 80 wt. % of the total inclusion particle content of the fluid stock.

27. The process of any one of the preceding claims, wherein the active electrode material-containing particles have an average smallest dimension of about 500 nm or less (e.g., about 10 nm to about 500 nm).

28. The process of any one of the preceding claims, wherein the active electrode material-containing particles have an average smallest dimension of about 0.5 micron to about 50 micron (e.g., about 0.5 micron to about 20 micron).

29. The process of any one of the preceding claims, wherein the active electrode material-containing particles and the plurality of carbon inclusions are different.

30. The process of claim 29, wherein the active electrode material-containing particles comprise a non-graphitic and non-graphenic active electrode material.

31. The process of any one of the preceding claims, wherein the first film has an externally exposed surface, the externally exposed surface being less than 20% (e.g., less than 15%, less than 10%, less than 5%, or the like) non-graphitic and non-graphenic active electrode material by surface area.

32. The process of any one of the preceding claims, wherein the first film has an externally exposed surface, the externally exposed surface being at least 80% graphenic by surface area.

33. The process of any one of the preceding claims, wherein the one or more first graphenic web comprises a plurality of first graphenic envelopes, the first graphenic envelopes comprising an external surface and an internal surface, the internal surface defining a graphenic pocket, one or more of the active electrode material-containing particles being configured within the graphenic pocket, and the graphenic envelope comprising one or more of the first graphene component(s).

34. The process of any one of the preceding claims, wherein the weight ratio of active electrode material-containing particles to first graphenic components present in the fluid stock being at least 1:4.

35. The process of claim 34, wherein the weight ratio of active electrode material-containing particles to first graphenic components present in the fluid stock being at least 1:2.

36. The process of claim 35, wherein the weight ratio of active electrode material-containing particles to first graphenic components present in the fluid stock being at least 1:1.

37. The process of any one of the preceding claims, wherein 1<b≤200, wherein b is the average number of active electrode material-containing particles configured within the graphenic pocket(s) (e.g., the active electrode material-containing particles being nanoparticles).

38. The process of any one of the preceding claims, wherein 1<b≤20, wherein b is the average number of active electrode material-containing particles configured within the graphenic pocket(s) (e.g., the active electrode material-containing particles being m icroparticles).

39. The process of any one of the preceding claims, wherein the first graphene component has an average lateral dimension that is equal to or greater than the average of the smallest dimension of the active electrode material -containing particles.

40. The process of any one of the preceding claims, wherein the plume or aerosol comprises a plurality of plume particles, and the plurality of plume particles within d/4 of the substrate having an average dimension of less than fifty times (e.g. less than 25 times, less than ten times, or the like) the average dimension of the active electrode material-containing particles.

41. A process for manufacturing an electrode, the process comprising the steps of any one of claims 1-40.

42. The process of claim 41, wherein the substrate is a current collector.

43. The process of claim 42, wherein the second composition is a second film and the second film is the electrode.

44. The process of claim 41, wherein the process further comprises removing the first or second composition from the substrate, grinding the first or second composition to form a powder, combining the powder with an additive (e.g., a binder, such as PVDF) to form a third composition, and casting the third composition on a current collector, forming the electrode on the current collector thereby.

45. The process of any one of claims 41-44, wherein the process further comprises conveying the substrate opposite the nozzle, and rolling the substrate after collecting the first composition thereon.

46. The process of claim 45, wherein the substrate is rolled after the first composition has been converted to the second composition.

47. The process of manufacturing a lithium ion battery anode, the process comprising the steps of any one of claims 41-46.

48. The process of manufacturing a lithium ion battery, the process comprising the steps of any one of claims 41-47.

49. The process of claim 48, further comprising assembling the lithium ion battery anode together with a separator and a cathode, the separator being positioned between the lithium ion battery anode and the cathode.

50. A process for manufacturing a silicon-carbon electrode material, the process comprising:
a. producing an electrostatically charged plume from a fluid stock by:
i. providing the fluid stock to a first inlet of a first conduit of an electrospray nozzle, the first conduit being enclosed along the length of the conduit by a first wall having an interior surface and an exterior surface, the first conduit having a first outlet,
the fluid stock comprising a plurality of inclusion particles and a liquid medium, the inclusion particles comprising a plurality of silicon-containing particles, and a plurality of multi-layered graphenic components,
the plurality of silicon-containing particles comprising SiOx, wherein 0≤x≤0.5, and having an average smallest dimension of about 0.5 micron to about 20 micron; and
the plurality of multi-layered graphenic components comprising at least 50 wt % carbon and about 10 wt % to about 50 wt % oxygen,
the weight ratio of silicon-containing particles to multi-layered graphenic components present in the fluid stock being at least 1:2,
ii. providing a voltage to the electrospray nozzle; and
b. collecting a first composition on a substrate, the first composition being a first film comprising the plurality of silicon-containing particles secured within one or more first graphenic web, the one or more first graphenic web comprising the plurality of first graphenic components.

51. The process of claim 50, further comprising providing a pressurized gas to a second inlet of a second conduit of the nozzle, the second conduit having a second inlet and a second outlet, and at least a portion of the second conduit being positioned in surrounding relation to the first conduit.

52. The process of either one of claim 50 or 51, wherein multi-layered graphenic component comprises at least 2 graphenic layers (e.g., at least 3 layers, at least 5 layers, 5-50 layers, 5-25 layers, or the like).

53. The process of any one of claims 50-52, wherein the gas has a velocity of at least 0.5 m/s at the second outlet.

54. The process any one of claims 50-52, wherein the process comprises collecting the first composition on a substrate, the substrate having a substrate surface in opposing relation to the electrospray nozzle.

55. The process of claim 54, wherein the electrostatically charged plume comprises a plurality of plume particles, and the plurality of plume particles within d/4 of the substrate comprise about 50 total inclusion particles or fewer, wherein d is the average distance between the first outlet of the nozzle and the substrate surface.

56. The process of any one of claims 54-55, wherein the substrate is affixed to or a part of a conveyor system.

57. The process of any one of claims 50-56, further comprising thermally treating the first composition to provide a second composition, the second composition comprising a plurality of thermally treated silicon-containing particles secured within one or more second graphenic web, the one or more second graphenic web comprising the plurality of second graphenic components, the plurality of second graphene components comprising about 85 wt. % or more carbon and about 0.1 wt. % to about 15 wt. % oxygen.

58. The process of any one of claims 50-57, wherein the second composition comprises about 50 wt. % to about 95 wt. % SiOx.

59. The process of any one of claims 50-58, wherein the second graphenic component constitutes about 5 wt. % to about 50 wt. % of the second composition.

60. The process of any one of claims 50-59, further comprising compressing the first and/or second composition(s).

61. The process of any one of claims 50-60, wherein the first and/or second composition has a thickness of about 1 mm or less.

62. The process of any one of claims 50-61, wherein the first composition has a bulk density of about 0.5 grams per cubic cm or more.

63. The process of any one of claims 50-62, wherein the silicon-containing particles and the plurality of first graphenic components constitute at least 80 wt. % of the total inclusion particle content of the fluid stock.

64. The process of any one of claims 50-63, wherein the first film and/or component parts thereof have an externally exposed surface, the externally exposed surface being less than 20% SiOx by surface area.

65. The process of any one of claims 50-64, wherein the first film and/or component parts thereof have an externally exposed surface, the externally exposed surface being at least 80% graphenic by surface area.

66. The process of any one of claims 50-65, wherein the one or more first graphenic web comprises a plurality of first graphenic envelopes, the first graphenic envelopes comprising an external surface and an internal surface, the internal surface defining a graphenic pocket, one or more of the silicon-containing particles being configured within the graphenic pocket, and the graphenic envelope comprising one or more of the first graphene component(s).

67. The process of any one of claims 50-66, wherein 1<b≤20, wherein b is the average number of silicon-containing particles configured within the graphenic pocket(s).

68. The process of any one of claims 50-67, wherein the first graphene component has an average lateral dimension that is equal to or greater than the average of the smallest dimension of the silicon-containing particles.

69. The process of any one of claims 50-68, wherein the electrostatically charged plume comprises a plurality of plume particles, and the plurality of plume particles within d/4 of the substrate having an average dimension of less than fifty times the average dimension of the silicon-containing particles.

70. A composition comprising a plurality of active electrode-containing particles and a plurality of multi-layered graphenic components,
the plurality of particles being secured within one or more carbonaceous web, the multi-layered graphenic components collectively forming the one or more carbonaceous web,
the particles having an average smallest dimension of about 0.01 micron to about 20 micron, and
the plurality of particles and the plurality of carbon components being present in the composition in a particles to multi-layered graphenic components weight ratio of about 1:10 to about 20:1.

71. The composition of claim 70, wherein the composition is a film.

72. The composition of any one of the preceding claims, wherein the film has a thickness of about 1 mm or less.

73. The composition of any one of the preceding claims, wherein the film has a thickness of about 0.2 mm or less.

74. The composition of any one of the preceding claims, wherein the film has a thickness of about 0.05 mm or less (e.g., about 0.01 mm to about 0.025 mm).

75. The composition of any one of the preceding claims, wherein the composition has a bulk density of about 0.3 grams per cubic cm or more.

76. The composition of any one of the preceding claims, wherein the composition has a bulk density of about 0.5 grams per cubic cm or more.

77. The composition of any one of the preceding claims, wherein the composition has a bulk density of about 0.5 grams per cubic cm or more.

78. The composition of any one of the preceding claims, wherein the carbonaceous component is a graphenic component.

79. The composition of any one of the preceding claims, wherein the active electrode containing particles comprise a non-graphenic and non-graphitic active electrode material.

80. The composition of any one of the preceding claims, wherein the active electrode containing particles are silicon containing particles.

81. The composition of any one of the preceding claims, wherein the active electrode containing particles comprise SiOx, wherein 0≤x≤1.5.

82. The composition of any one of the preceding claims, wherein the active electrode containing particles comprise SiOx, wherein 0≤x≤0.5.

83. The composition of any one of the preceding claims, wherein the active electrode containing particles are particles having an average smallest dimension of about 0.1 micron to about 20 micron.

84. The composition of any one of the preceding claims, wherein the plurality of carbon components being present in the composition in a particles to graphenic components weight ratio of about 1:2 to about 10:1.

85. The composition of any one of the preceding claims, wherein the multi-layered graphenic component is an oxidized multi-layered graphenic component (e.g., multi-layered graphene oxide).

86. The composition of any one of the preceding claims, wherein at least 80% of the surface of the film is carbonaceous.

87. The composition of any one of the preceding claims, wherein at least 80% of the surface of the film is graphenic.

88. The composition of any one of the preceding claims, wherein the composition and/or component parts thereof have an externally exposed surface, the externally exposed surface being less than 30% (e.g., less than 20%, less than 10%, or less than 5%) non-carbonaceous active electrode material by surface area.

89. The composition of any one of the preceding claims, wherein the composition and/or component parts thereof have an externally exposed surface, the externally exposed surface being less than 20% SiOx by surface area.

90. The composition of any one of the preceding claims, wherein the composition has an externally exposed surface, the externally exposed surface being at least 70% (e.g., at least 80%, at least 90%, at least 95%, or the like) carbonaceous by surface area.

91. The composition of any one of the preceding claims, wherein the composition has an externally exposed surface, the externally exposed surface being at least 80% graphenic by surface area.

92. The composition of any one of the preceding claims, wherein the active particles and the carbon components constitute at least 80 wt. % of the composition.

93. The composition of any one of the preceding claims, wherein the active particles and the carbon components constitute at least 90 wt. % of the composition.

94. The composition of any one of the preceding claims, wherein the active particles and the carbon components constitute at least 95 wt. % of the composition.

95. The composition of any one of the preceding claims, wherein the active particles constitute about 50 wt. % to about 95 wt. % of the composition.

96. The composition of any one of the preceding claims, wherein the graphenic components constitute about 5 wt. % to about 50 wt. % of the composition.

97. The composition of any one of the preceding claims, wherein the graphenic components constitute about 5 wt. % to about 50 wt. % of the composition.

98. The composition of any one of the preceding claims, wherein the graphenic components collectively comprise at least 90 wt. % carbon and about 0.1 wt. % to about 10 wt. % oxygen.

99. The composition of any one of the preceding claims, wherein the carbon components collectively comprise at least 50 wt. % carbon and about 5 wt. % to about 50 wt. % oxygen.

100. The composition of any one of the preceding claims, wherein the one or more carbonaceous web defines a plurality of pockets with one or more of the particles being configured therewithin.

101. The composition of claim 100, wherein 1<b≤20, wherein b is the average number of particles configured within the pocket(s) having particles configured therewithin.

102. The composition of claim 101, wherein 1<b≤5.

103. The composition of any one of claims 100-102, wherein at least 70% (e.g., at least 80%, at least 90%, or at least 95%) of the particles are configured within the pocket(s).

104. The composition of any one of the preceding claims, wherein the carbon component has an average lateral dimension that is equal to or greater than the average of the smallest dimension of the particles.

105. The composition of claim 104, wherein the average lateral dimension of the carbon component is about ten times or less the average of the smallest dimension of the particles.

106. A composition comprising a plurality of silicon-containing particles and a plurality of oxidized multi-layered graphene components,
the plurality of silicon-containing particles being secured within one or more graphenic web, the plurality of oxidized multi-layered graphene components collectively forming the one or more graphenic web,
the silicon-containing particles comprising SiOx, wherein 0≤x≤0.5, and having an average smallest dimension of about 0.5 micron to about 20 micron, and
the plurality of silicon-containing particles and the plurality of oxidized graphene components being present in the composition in a silicon-containing particles to oxidized multi-layered graphene components weight ratio of about 1:2 to about 10:1.

107. The composition of any one of the preceding claims, wherein the composition is a film.

108. The composition of any one of the preceding claims, wherein the film has a thickness of about 1 mm or less.

109. The composition of any one of the preceding claims, wherein the film has a thickness of about 0.2 mm or less.

110. The composition of any one of the preceding claims, wherein the composition has a bulk density of about 0.5 grams per cubic cm or more.

111. The composition of any one of the preceding claims, wherein at least 80% of the surface of the film is graphenic.

112. The composition of any one of the preceding claims, wherein the composition and/or component parts thereof have an externally exposed surface, the externally exposed surface being less than 20% SiOx by surface area.

113. The composition of any one of the preceding claims, wherein the composition and/or component parts thereof have an externally exposed surface, the externally exposed surface being at least 80% graphenic by surface area.

114. The composition of any one of the preceding claims, wherein the silicon-containing particles and the oxidized graphene components constitute at least 80 wt. % of the composition.

115. The composition of any one of the preceding claims, wherein the silicon-containing particles and the oxidized graphene components constitute at least 95 wt. % of the composition.

116. The composition of any one of the preceding claims, wherein the silicon-containing particles constitute about 50 wt. % to about 95 wt. % of the composition.

117. The composition of any one of the preceding claims, wherein the oxidized graphene components constitute about 5 wt. % to about 50 wt. % of the composition.

118. The composition of any one of the preceding claims, wherein the oxidized graphene components comprise at least 90 wt. % carbon and about 0.1 wt. % to about 10 wt. % oxygen.

119. The composition of any one of the preceding claims, wherein the oxidized graphene components comprise at least 50 wt. % carbon and about 5 wt. % to about 50 wt. % oxygen.

120. The composition of any one of the preceding claims, wherein the one or more graphenic web defines a plurality of graphenic pockets with one or more of the silicon-containing particles being configured therewithin.

121. The composition of any one of the preceding claims, wherein 1<b≤20, wherein b is the average number of silicon-containing particles configured within the graphenic pocket(s) having silicon-containing particles configured therewithin.

122. The composition of any one of the preceding claims, wherein 1<b≤5.

123. The composition of any one of the preceding claims, wherein at least 80% of the silicon-containing particles are configured within the graphenic pocket(s).

124. The composition of any one of the preceding claims, wherein the oxidized graphene component has an average lateral dimension that is equal to or greater than the average of the smallest dimension of the silicon-containing particles.

125. The composition of any one of the preceding claims, wherein the average lateral dimension of the oxidized graphene component is about ten times or less the average of the smallest dimension of the silicon-containing particles.

126. A composite particle comprising one or more subparticle(s) and a graphenic web,
the graphenic web comprising one or more multi-layered graphene component(s),
the graphenic web defining one or more graphenic pocket(s) within the graphenic web,
the subparticle comprising a (non-graphitic) active electrode material,
the one or more subparticle(s) being configured within the one or more graphenic pocket(s),
the composite particle having an external surface, less than 10% of the external surface by area being comprised of a (non-graphitic) active electrode material,
the one or more subparticle(s) making up about 30 wt. % to about 90 wt. % of the silicon-carbon composite particle, and
the graphenic web making up about 10 wt. % to about 70 wt. % of the composite particle.

127. The particle of any one of the preceding claims, wherein the one or more graphene component(s) comprising at least 50 wt. % carbon and about 0.1 wt. % to about 50 wt. % oxygen.

128. The particle of any one of the preceding claims, wherein the (non-graphitic) active electrode material is SiOx, wherein 0≤x≤1.5.

129. The particle of any one of the preceding claims, wherein the (non-graphitic) active electrode material is SiOx, wherein 0≤x≤0.5.

130. The particle of any one of the preceding claims, wherein the one or more subparticle(s) and the graphenic web combine to make up at least 70 wt. % (e.g., at least 80 wt. %, at least 90 wt. %, or at least 95 wt. %) of the particle.

131. The particle of any one of the preceding claims, wherein greater than 80% (e.g., greater than 90%, or greater than 95%) of the external surface by area is comprised of the graphenic web.

132. The particle of any one of the preceding claims, wherein a network of two or more graphene components collectively form the graphenic web.

133. The particle of any one of the preceding claims, wherein the one or more subparticle(s) have an average smallest dimension of about 0.01 micron to about 25 micron.

134. The particle of any one of the preceding claims, wherein the one or more subparticle(s) have an average smallest dimension of about 0.5 micron to about 20 micron.

135. The particle of any one of the preceding claims, wherein the average length of the one or more graphene component is about equal to or greater than the average smallest dimension of the one or more subparticle(s).

136. The particle of any one of the preceding claims, wherein the average length of the one or more graphene component is about equal to or greater than, but less than ten times, the average smallest dimension of the one or more subparticle(s).

137. The particle of any one of the preceding claims, wherein the one or more graphene component(s) comprising at least 60 wt. % carbon and about 10 wt. % to about 40 wt. % oxygen.

138. The particle of any one of the preceding claims, wherein the weight ratio of subparticle to graphene component is about 1:2 to about 4:1.

139. The particle of any one of the preceding claims, wherein the one or more graphene component(s) comprising at least 90 wt. % carbon and about 0.1 wt. % to about 10 wt. % oxygen.

140. The particle of any one of the preceding claims, wherein the weight ratio of subparticle to graphene component is about 1:1 to about 10:1.

141. The particle of any one of the preceding claims, wherein the graphenic pocket has a volume at least 10% greater than the volume of the subparticles present therein.

142. The particle of any one of the preceding claims, wherein the particle comprises a single graphenic pocket with subparticle(s) configured therewithin.

143. The particle of any one of the preceding claims, wherein the single graphenic pocket comprises 1-20 subparticle(s) configured therewithin.

144. The particle of any one of the preceding claims, having an aspect ratio of 1 to about 100.

145. The particle or composition of any one of the preceding claims, wherein the graphene component comprises 1-20 layers.

146. A silicon-carbon composite particle comprising one or more silicon-containing subparticle(s) and a graphenic web,
the graphenic web comprising one or more multi-layered graphene component(s), the one or more graphene component(s) comprising at least 50 wt. % carbon and about 0.1 wt. % to about 50 wt. % oxygen,
the graphenic web defining one or more graphenic pocket(s) within the graphenic web,
the silicon-containing subparticle comprising SiOx, wherein 0≤x≤0.5,
the one or more silicon-containing subparticle(s) being configured within the one or more graphenic pocket(s),
the silicon-carbon composite particle having an external surface, less than 10% of the external surface by area being comprised of SiOx,
the one or more silicon-containing subparticle(s) making up about 30 wt. % to about 90 wt. % of the silicon-carbon composite particle, and
the graphenic web making up about 10 wt. % to about 70 wt. % of the silicon-carbon composite particle.

147. The particle of any one of the preceding claims, wherein the one or more silicon-containing subparticle(s) and the graphenic web combine to make up at least 90 wt. % of the particle.

148. The particle of any one of the preceding claims, wherein greater than 95% of the external surface by area is comprised of the graphenic web.

149. The particle of any one of the preceding claims, wherein a network of two or more graphene components collectively form the graphenic web.

150. The particle of any one of the preceding claims, wherein the one or more silicon-containing subparticle(s) have an average smallest dimension of about 0.5 micron to about 20 micron.

151. The particle of any one of the preceding claims, wherein the average length of the one or more graphene component is about equal to or greater than the average smallest dimension of the one or more silicon-containing subparticle(s).

152. The particle of any one of the preceding claims, wherein the one or more graphene component(s) comprising at least 60 wt. % carbon and about 10 wt. % to about 40 wt. % oxygen.

153. The particle of any one of the preceding claims, wherein the weight ratio of silicon-containing subparticle to graphene component is about 1:2 to about 4:1.

154. The particle of any one of the preceding claims, wherein the one or more graphene component(s) comprising at least 90 wt. % carbon and about 0.1 wt. % to about 10 wt. % oxygen.

155. The particle of any one of the preceding claims, wherein the weight ratio of silicon-containing subparticle to graphene component is about 1:1 to about 10:1.

156. The particle of any one of the preceding claims, wherein the graphenic pocket has a volume at least 10% greater than the volume of the silicon-containing subparticles present therein.

157. The particle of any one of the preceding claims, wherein the particle comprises a single graphenic pocket with silicon-containing subparticle(s) configured therewithin.

158. The particle of any one of the preceding claims, wherein the single graphenic pocket comprises 1-5 silicon-containing subparticle(s) configured therewithin, and the silicon-containing subparticle(s) have an average smallest dimension of about 0.5 micron to about 20 micron.

159. The particle of any one of the preceding claims, having an aspect ratio of 1 to about

100.

160. The particle of any one of the preceding claims, wherein the graphene component comprises 1-20 layers.

161. The particle of any one of the preceding claims, wherein
the one or more silicon-containing subparticle(s) and the graphenic web combine to make up at least 90 wt. % of the particle,
greater than 90% of the external surface by area is comprised of the graphenic web,
the one or more silicon-containing subparticle(s) have an average smallest dimension of about 0.5 micron to about 20 micron,
the average length of the one or more graphene component is about equal to or greater than the average smallest dimension of the one or more silicon-containing subparticle(s),
the one or more graphene component(s) is graphene oxide comprising at least 60 wt. % carbon and about 10 wt. % to about 40 wt. % oxygen, and
the weight ratio of silicon-containing subparticle to graphene component is about 1:2 to about 4:1.

162. The particle of any one of the preceding claims, wherein the particle comprises a single graphenic pocket with 1-20 (e.g., 1-5) silicon-containing subparticle(s) configured therewithin.

163. The particle of any one of the preceding claims, wherein the graphenic pocket has a volume at least 10% greater than the volume of the silicon-containing subparticles present therein.

164. The particle of any one of the preceding claims, wherein
the one or more silicon-containing subparticle(s) and the graphenic web combine to make up at least 90 wt. % of the particle,
greater than 90% of the external surface by area is comprised of the graphenic web,
the one or more silicon-containing subparticle(s) have an average smallest dimension of about 0.5 micron to about 20 micron,
the average length of the one or more graphene component is about equal to or greater than the average smallest dimension of the one or more silicon-containing subparticle(s),
the one or more graphene component(s) is reduced graphene oxide comprising at least 90 wt. % carbon and about 0.1 wt. % to about 10 wt. % oxygen, and
the weight ratio of silicon-containing subparticle to graphene component is about 1:1 to about 10:1.

165. The particle of any one of the preceding claims, wherein the particle comprises a single graphenic pocket with 1-20 (e.g., 1-5) silicon-containing subparticle(s) configured therewithin.

166. An aqueous composition comprising a plurality of inclusion particles and a liquid medium, the inclusion particles comprising a plurality of active electrode-containing particles, and a plurality of multi-layered graphenic inclusions, the plurality of active electrode-containing particles comprising a non-graphitic active electrode material (e.g., SiOx, wherein 0≤x≤1.5), the plurality of carbon inclusions comprising a plurality of graphene components, the weight ratio of particles to graphene components being at least 1:2,

167. The aqueous composition of claim 166, wherein the multi-layered graphenic inclusions comprising, on average, at least 50 wt % carbon and about 10 wt % to about 50 wt % oxygen.

168. A fluid composition of any one of claims 1-69.

169. An aerosol or plume of any one of claims 1-69.

170. A battery comprising a composition of any one of claims 70-125.

171. The battery of claim 170, wherein the battery is a lithium ion battery.

172. An electrode comprising a composition of any one of claims 70-125.

173. A battery comprising a composite particle of any one of claims 126-165.

174. The battery of claim 173, wherein the battery is a lithium ion battery.

175. An electrode comprising a composite particle of any one of claims 126-165.

176. The electrode of claim 175, wherein the electrode further comprises graphite and/or a binder (e.g., PVDF).

177. The electrode of any one of claims 175-176, wherein the electrode comprises one or more particle of any one of claims 126-165, and the one or more particle of any one of claims 126-165 make up at least 5 wt % (e.g., at least 10 wt. %, at least 15 wt %, at least 20 wt %, or the like) of the electrode.
